(19) United States
(12) Patent Application Publication
(10) Pub. No.: US 2012/0146557 A1
(43) Pub. Date: Jun. 14, 2012

(54) VIBRATION GENERATING MODULE, ACTUATOR USING THE SAME, HANDHELD DEVICE, METHOD FOR GENERATING VIBRATION AND RECORDING MEDIUM THEREOF

(75) Inventors: Dongbum Pyo, Gyeonggi-do (KR); Tae-Heon Yang, Daejeon (KR); Young-jun Cho, Seoul (KR); Dong-Soo Kwon, Daejeon (KR)

(73) Assignee: Korea Advanced Institute of Science and Technology, Yusung-gu (KR)

(21) Appl. No.: 13/088,860

(22) Filed: Apr. 18, 2011

(30) Foreign Application Priority Data
Dec. 9, 2010 (KR) 10-2010-0125579
Dec. 23, 2010 (KR) 10-2010-0133092

(51) Int. Cl. H02K 33/18; H02P 31/00

(52) U.S. Cl. 318/129; 310/25

(57) ABSTRACT

The present invention relates to a vibration generating module and an actuator using the same, and more specifically, to an invention for generating vibration using an unstable structure, in which magnetic force is generated using permanent magnets and a solenoid for generating alternating electromagnetic force, and the vibration is generated by inertia or impact as the permanent magnets or the solenoid is moved by the generated magnetic force. To this end, disclosed is a vibration generating module comprising: a magnetic force generating means 110 for generating magnetic force; and an electromagnetic force generating means 120 for generating electromagnetic force alternating depending on a magnetic pole change signal, in which vibration is generated as the magnetic force generating means 110 or the electromagnetic force generating means 120 is moved to one direction according to the magnetic pole change signal.

### TECHNICAL FIELD

The present invention relates to a vibration generating module and an actuator using the same, and more specifically, to an invention for generating vibration using an unstable structure, in which magnetic force is generated using permanent magnets and a solenoid for generating alternating electromagnetic force, and the vibration is generated by inertia or impact as the permanent magnets or the solenoid is moved by the generated magnetic force.

### BACKGROUND ART

Recently, utilization of touch screens tends to increase significantly with distribution of handheld electronic devices. In line with the trend, keypads conventionally used in the form of a click dome are implemented on a touch screen recently.

The keypads implemented on a touch screen have a problem in that it is unknown whether or not a user has inputted data if there is no vibration or haptic feedback. Therefore, efforts have been made to remove inconvenience of confirming the values inputted through the touch screen one by one by generating a sense of touch delivered through vibration, which is a kind of haptic feedback, at a handheld electronic device where an input device of a touch screen method is used.

However, since conventional coin-shaped or bar-shaped vibration motors have an extended response time, there is a limit in implementing haptic feedback functions. On the other hand, although linear motors having a short response time, low power consumption, and high reliability have been proposed, the conventional linear motors have only one resonant frequency, and vibration power is abruptly lowered if they deviate from the resonant frequency only by 2 or 3 Hz. Furthermore, since the linear motors still have a delayed response time of about 25 ms, there is a limit in mimicking a sense of click on a real button and providing a variety of haptic vibration patterns.

On the other hand, conventional inventions use a stable structure in order to provide a cellular phone with a sense of touch delivered through vibration. However, there is a problem in that haptic feedback based on the stable structure generates a weak impact vibration.

Therefore, in the technical field of the present invention, it has been requested to develop a vibration generating module having a short response time that can be attached to a handheld electronic device and the like.

### DISCLOSURE OF INVENTION

### Technical Problem

Therefore, the present invention has been made in view of the above problems, and it is an object of the present invention to provide a vibration generating module, which has a considerably short response time, does not generate excitation when the impact vibration is generated, and generates strong impact vibration, using permanent magnets, a solenoid for generating alternating electromagnetic force, and an unstable structure.

However, the objects of the present invention are not limited thereto, but other objects that have not been described can be understood to those skilled in the art from the descriptions described below.

### Technical Solution

To accomplish the above object, according to one aspect of the present invention, there is provided a vibration generating module comprising: a magnetic force generating means 110 for generating magnetic force; and an electromagnetic force generating means 120 for generating electromagnetic force alternating depending on a magnetic pole change signal, wherein vibration is generated as the magnetic force generating means 110 or the electromagnetic force generating means 120 is moved to one direction according to the magnetic pole change signal.

According to another aspect of the present invention, there is provided an actuator comprising: a vibration generating module 100 including: a magnetic force generating means 110 for generating magnetic force; and an electromagnetic force generating means 120 for generating electromagnetic force alternating depending on a magnetic pole change signal; and a control means 210 for outputting the magnetic pole change signal to the electromagnetic force generating means 120, wherein vibration is generated as the magnetic force generating means 110 or the electromagnetic force generating means 120 is moved to one direction according to the magnetic pole change signal.

According to another aspect of the present, invention, there is provided a handheld device capable of generating vibration, the device comprising: a vibration generating module 100 including: a magnetic force generating means 110 for generating magnetic force; and an electromagnetic force generating means 120 for generating electromagnetic force alternating depending on a magnetic pole change signal; and an actuator 200 including a control means 210 for outputting the magnetic pole change signal to the electromagnetic force generating means 120, wherein the vibration is generated as the magnetic force generating means 110 or the electromagnetic force generating means 120 is moved to one direction according to the magnetic pole change signal.

According to another aspect of the present invention, there is provided a method for generating vibration using an actuator, the method comprising the steps of: outputting a control signal to an electromagnetic force generating means 120, by a control means 210 S110; generating electromagnetic force according to the control signal, by the electromagnetic force generating means 120 S120; forming magnetic poles of the electromagnetic force generating means 120 based on the electromagnetic force S130; generating magnetic force by the magnetic poles of the electromagnetic force generating means 120 and the magnetic force generating means 110 S140; and generating the vibration by moving and colliding the magnetic force generating means 110 by the magnetic force S150.

According to another aspect of the present invention, there is provided a method for generating vibration using an actuator, the method comprising the steps of: outputting a control signal to an electromagnetic force generating means 120, by a control means 210 S210; generating electromagnetic force according to the control signal, by the electromagnetic force generating means 120 S220; forming magnetic poles of the electromagnetic force generating means 120 based on the electromagnetic force S230; generating magnetic force by the magnetic poles of the electromagnetic force generating means 120 and the magnetic force generating means 110 S240; and generating the vibration by moving and colliding the electromagnetic force generating means 120 by the magnetic force S250.

According to another aspect of the present invention, there is provided a computer-readable recording medium for recording a program for executing a method for generating vibration.

According to another aspect of the present invention, there is provided a vibration generating module comprising: a plurality of magnetic force generating means 1110 for generating magnetic force; and an electromagnetic force generating means 1120 for generating electromagnetic force alternating depending on a magnetic pole change signal, wherein the vibration generating module is configured in an unstable structure, in which a local magnetic path 10A is formed based on magnetic force lines of the magnetic force generating means 1110 and the electromagnetic force generating means 1120, and vibration is generated as the magnetic force generating means 1110 or the electromagnetic force generating means 1120 is moved to one direction according to the magnetic pole change signal.

According to another aspect of the present invention, there is provided an actuator comprising: a vibration generating module 1100 including: a magnetic force generating means 1110 for generating magnetic force; and an electromagnetic force generating means 1120 for generating electromagnetic force alternating depending on a magnetic pole change signal; and a control means 1210 for outputting the magnetic pole change signal to the electromagnetic force generating means 1120, wherein the actuator is configured in an unstable structure, in which a local magnetic path 10A is formed based on magnetic force lines of the magnetic force generating means 1110 and the electromagnetic force generating means 1120, and vibration is generated as the magnetic force generating means 1110 or the electromagnetic force generating means 1120 is moved to one direction according to the magnetic pole change signal.

According to another aspect of the present invention, there is provided a handheld device capable of generating vibration, the device comprising: a vibration generating module 1100 including: a magnetic force generating means 1110 for generating magnetic force; and an electromagnetic force generating means 1120 for generating electromagnetic force alternating depending on a magnetic pole change signal; and an actuator 1200 including a Control means 1210 for outputting the magnetic pole change signal to the electromagnetic force generating means 1120, wherein the handheld device is configured in an unstable structure, in which a local magnetic path 10A is formed based on magnetic force lines of the magnetic force generating means 1110 and the electromagnetic force generating means 1120, and the vibration is generated as the magnetic force generating means 1110 or the electromagnetic force generating means 1120 is moved to one direction according to the magnetic pole change signal.

According to another aspect of the present invention, there is provided a method for generating vibration using an actuator, the method comprising the steps of: outputting a control signal to an electromagnetic force generating means 1120, by a control means 1210 S1110; generating electromagnetic force according to the control signal, by the electromagnetic force generating means 1120 S1120; forming magnetic poles of the electromagnetic force generating means 1120 based on the electromagnetic force S1130; generating magnetic force by the magnetic poles of the electromagnetic force generating means 1120 and the plurality of magnetic force generating means 1110 S1140; and generating the vibration by moving and colliding the plurality of magnetic force generating means 1110 by the magnetic force S1150, wherein the vibration generating method is performed in an unstable structure, in which a local magnetic path 10A is formed based on magnetic force lines of the electromagnetic force generating means 1120 and the magnetic force generating means 1110.

According to another aspect of the present invention, there is provided a method for generating vibration using an actuator, the method comprising the steps of: outputting a control signal to an electromagnetic force generating means 1120, by a control means 1210 S1210; generating electromagnetic force according to the control signal, by the electromagnetic force generating means 1120 S1220; forming magnetic poles of the electromagnetic force generating means 1120 based on the electromagnetic force S1230; generating magnetic force by the magnetic poles of the electromagnetic force generating means 1120 and the plurality of magnetic force generating means 1110 S1240; and generating the vibration by moving and colliding the electromagnetic force generating means 1120 by the magnetic force S1250, wherein the vibration generating method is performed in an unstable structure, in which a local magnetic path 10A is formed based on magnetic force lines of the electromagnetic force generating means 1120 and the magnetic force generating means 1110.

### Advantageous Effects

According to the present invention described above, there is provided a vibration generating module having a considerably short response time for generating strong impact vibration using permanent magnets, a solenoid for generating alternating electromagnetic force, and an unstable structure.

In addition, according to the present invention, there is provided a vibration generating module, the structure of which is simplified and miniaturized to lower cost and significantly reduce power consumption.

In addition, according to the present invention, the force unnecessarily generated in the y-axis direction is removed, and the force in the x-axis direction can be maximized.

In addition, a further intense sense of touch can be delivered to a user through vibration by increasing the resonant frequency using elasticity.

In addition, according to the present invention, a vibration generating module having a significantly short response time is attached to a handheld device, and thus a sense of touch can be delivered through highly responsive vibration when a touch screen is pressed.

### BRIEF DESCRIPTION OF THE DRAWINGS

The above and other objects, features and advantages of the present invention will be apparent from the following detailed description of the preferred embodiments of the present invention in conjunction with the accompanying drawings.

FIGS. 1 to 23 are views showing a first embodiment of the present invention.

FIGS. 1 and 2 are views showing a configuration where an elastic means of a vibration generating module is combined with a first mobile object according to a first embodiment of the present invention.

FIGS. 3 and 4 are views showing a configuration where an elastic means of a vibration generating module is combined with a second mobile object according to a first embodiment of the present invention.

FIGS. 5 to 7 are views showing a concept of moving a first mobile object using two magnetic force generating means and an electromagnetic force generating means according to a first embodiment of the present invention.

FIGS. 8 to 10 are views showing a concept of moving a first mobile object using four magnetic force generating means and an electromagnetic force generating means according to a first embodiment of the present invention.

FIGS. 11 to 13 are views showing a concept of moving a second mobile object using two magnetic force generating means and an electromagnetic force generating means according to a first embodiment of the present invention.

FIGS. 14 to 16 are views showing a concept of moving a second mobile object using four magnetic force generating means and an electromagnetic force generating means according to a first embodiment of the present invention.

FIGS. 17 and 18 are views showing a magnetic path according to a first embodiment of the present invention.

FIG. 19 is a view showing the configuration of an actuator according to a first embodiment of the present invention.

FIG. 20 is a view showing the configuration of a handheld device according to a first embodiment of the present invention.

FIG. 21 is a front view showing a handheld device according to a first embodiment of the present invention.

FIG. 22 is a flowchart sequentially illustrating a vibration generating method based on the movement of a magnetic force generating means according to a first embodiment of the present invention.

FIG. 23 is a flowchart sequentially illustrating a vibration generating method based on the movement of an electromagnetic force generating means according to a first embodiment of the present invention.

FIGS. 24 to 41 are views showing a second embodiment of the present invention.

FIGS. 24 and 25 are views showing a configuration of generating vibration by inertia according to a second embodiment of the present invention.

FIG. 24 is a view showing a configuration where an elastic means of a vibration generating module is combined with an electromagnetic force generating means according to a second embodiment of the present invention.

FIG. 25 is a view showing a configuration where an elastic means of a vibration generating module is combined with a second mobile object according to a second embodiment of the present invention.

FIGS. 26 and 27 are views showing a configuration of generating vibration by impact according to a second embodiment of the present invention.

FIG. 26 is a view showing a configuration where an elastic means of a vibration generating module is combined with a first mobile object according to a second embodiment of the present invention.

FIG. 27 is a view showing a configuration where an elastic means of a vibration generating module is combined with a second mobile object according to a second embodiment of the present invention.

FIG. 28 is a view showing a concept of moving an electromagnetic force generating means or a first mobile object of a vibration generating module to the left according to a second embodiment of the present invention.

FIG. 29 is a view showing a concept of moving an electromagnetic force generating means or a first mobile object of a vibration generating module to the right according to a second embodiment of the present invention.

FIG. 30 is a view showing a concept of moving a second mobile object of a vibration generating module to the right according to a second embodiment of the present invention.

FIG. 31 is a view showing a concept of moving a second mobile object of a vibration generating module to the left according to a second embodiment of the present invention.

FIGS. 32 to 36 are views showing local magnetic paths according to a second embodiment of the present invention.

FIG. 32 is a view showing local magnetic paths when magnetic poles are not formed at the electromagnetic force generating means of a vibration generating module according to a second embodiment of the present invention.

FIG. 33 is a view showing local magnetic paths when magnetic poles are formed at the electromagnetic force generating means of a vibration generating module and the electromagnetic force generating means or a first mobile object is moved to the left according to a second embodiment of the present invention.

FIG. 34 is a view showing local magnetic paths when magnetic poles are formed at the electromagnetic force generating means of a vibration generating module and the electromagnetic force generating means or the first mobile object is moved to the right according to a second embodiment of the present invention.

FIG. 35 is a view showing local magnetic paths when magnetic poles are formed at the electromagnetic force generating means of a vibration generating module and the second mobile object is moved to the right according to a second embodiment of the present invention.

FIG. 36 is a view showing local magnetic paths when magnetic poles are formed at the electromagnetic force generating means of a vibration generating module and the second mobile object is moved to the left according to a second embodiment of the present invention.

FIG. 37 is a view showing the configuration of an actuator according to a second embodiment of the present invention.

FIG. 38 is a view showing the configuration of a handheld device according to a second embodiment of the present invention.

FIG. 39 is a front view showing a handheld device according to a second embodiment of the present invention.

FIG. 40 is a flowchart sequentially illustrating a vibration generating method using an unstable structure based on the movement of a magnetic force generating means according to a second embodiment of the present invention.

FIG. 41 is a flowchart sequentially illustrating a vibration generating method using an unstable structure based on the movement of an electromagnetic force generating means according to a second embodiment of the present invention.

### BEST MODE FOR CARRYING OUT THE INVENTION

Hereinafter, preferred embodiments of the present invention will be described in more detail with reference to the accompanying drawings. However, the present invention is not limited to the preferred embodiments thereof set forth herein but can be implemented in different forms. Rather, the preferred embodiments are merely provided to allow the present invention to be completely described herein and to fully convey the scope of the invention to those skilled in the art.

### Configuration of Vibration Generating Module According to First Embodiment

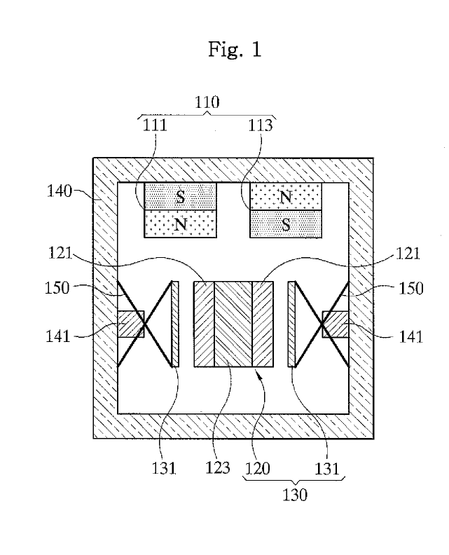

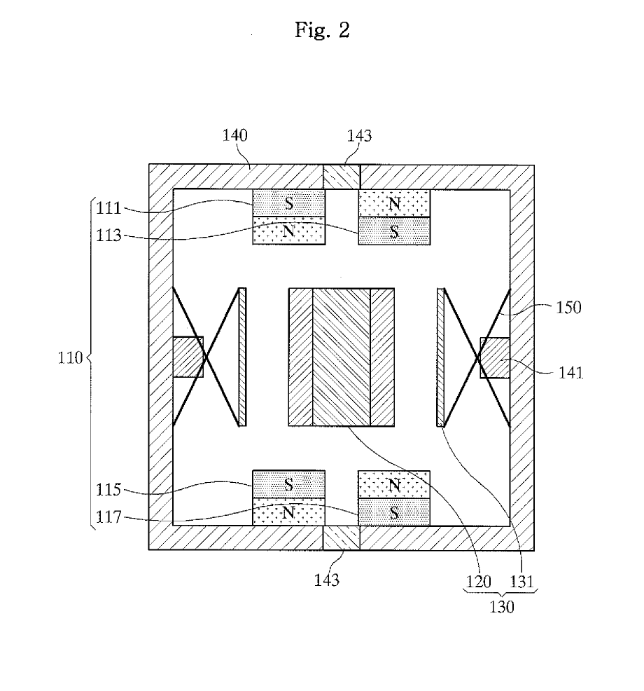

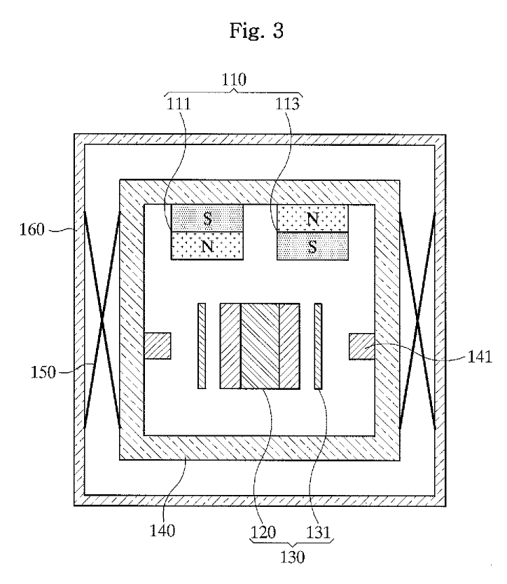

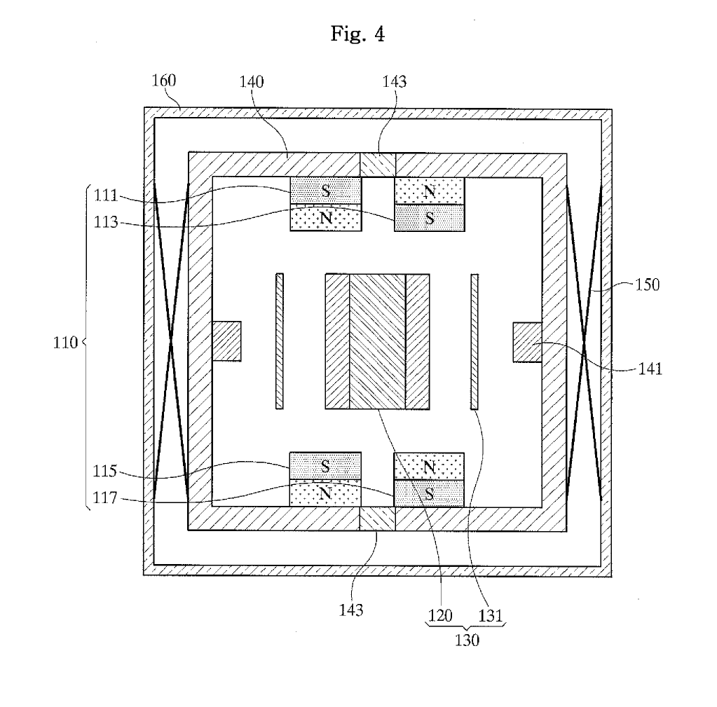

FIGS. 1 and 2 are views showing a configuration where an elastic means of a vibration generating module is combined with a first mobile object according to a first embodiment of the present invention, and FIGS. 3 and 4 are views showing a configuration where an elastic means of a vibration generating module is combined with a second mobile object according to a first embodiment of the present invention.

As shown in FIG. 1, a vibration generating module according to a first embodiment of the present invention may comprise a magnetic force generating means 110 and an electromagnetic force generating means 120, and preferably further comprises a first mobile object 130, a second mobile object 140, elastic means 150, and a housing 160. Hereinafter, the configuration of the vibration generating module according to a first embodiment of the present invention will be described with reference to FIGS. 1 to 4.

The magnetic force generating means 110 according to a first embodiment of the present invention is a means for generating magnetic force using permanent magnets. As shown in FIGS. 1 and 3, the magnetic force generating means 110 may be provided with two permanent magnets. Accordingly, the two permanent magnets should be formed such that magnetic poles facing each other are magnetic poles different from each other. That is, if either of the facing magnetic poles of a first magnetic force generating means 111, and a second magnetic force generating means 113 is the south pole (S-pole), the opposing magnetic pole should be the north pole (N-pole). Since either of magnetic poles formed at the electromagnetic force generating means 120 described below is opposed to the magnetic poles of the first and second magnetic force generating means 111 and 113, the magnetic force is generated.

On the other hand, as shown in FIGS. 2 and 4, the magnetic force generating means 110 may be provided with four permanent magnets. If the magnetic force generating means 110 is provided with four permanent magnets, unnecessary components of magnetic force in the y-axis direction can be offset to the maximum, and magnetic force in the x-axis direction can be increased.

At this point, the four permanent magnets should be formed such that magnetic poles facing each other are magnetic poles different from each other. That is, if either of the facing magnetic poles of the first and second magnetic force generating means 111 and 113 is the S-pole, the opposing magnetic pole should be the N-pole, and it is the same for a third magnetic force generating means 115 and a fourth magnetic force generating means 117. In addition, if either of the facing magnetic poles of the first and third magnetic force generating means 111 and 115 is the S-pole, the opposing magnetic pole should be the N-pole, and it is the same for the second and fourth magnetic force generating means 113 and 117. Since both of the magnetic poles formed at the electromagnetic force generating means 120 are opposed to the magnetic poles of the first, second, third, and fourth magnetic force generating means 111, 113, 115 and 117, the magnetic force is generated.

The electromagnetic force generating means 120 according to a first embodiment of the present invention is a means for generating electromagnetic force alternating depending on a magnetic pole change signal. The electromagnetic force generating means 120 generates magnetic fields using a solenoid and is provided with an iron core 123 inside. The electromagnetic force generating means 120 can generate further stronger magnetic fields by winding a solenoid coil 121. Since strength of the magnetic fields at the solenoid is proportional to the number of turns of the coil and strength of current, the number of turns of the coil needs to be increased in order to increase the strength of the magnetic fields.

On the other hand, both of the magnetic poles formed at the electromagnetic force generating means 120 are magnetic poles alternating by a control means 210 described below. At least either of the alternating magnetic poles is opposed to the magnetic pole of the magnetic force generating means 110, and thus the magnetic force is generated and starts to act.

The first mobile object 130 according to a first embodiment of the present invention comprises a protecting means 131 and an electromagnetic force generating means 120. Since the electromagnetic force generating means 120 is the same as described above, the aforementioned descriptions substitute for descriptions thereof, and the protecting means 131 will be described hereinafter.

The protecting means 131 protects the electromagnetic force generating means 120 from impact when the first mobile object 130 generates vibration by impact. Accordingly, although it is preferable that the protecting means 131 is formed of non-magnetic material such as silicon or the like to protect the electromagnetic force generating means 120 from the impact, it is apparent to those skilled in the art that it is not limited only to the silicon.

The second mobile object 140 according to a first embodiment of the present invention comprises a plurality of magnetic force generating means 110 and limiter means 141, and preferably further comprises connecting means 143. The aforementioned descriptions substitute for descriptions of the magnetic force generating means 110, and the limiter means 141 and the connecting means 143 will be described hereinafter.

The limiter means 141 are provided at both inner sides of the second mobile object 140, limits the range of movement of the first or the second mobile object 130 or 140, and generates vibration by collision with the protecting means 131. Although the limiter means 141 can be formed of silicon, it is not limited thereto, and it is apparent to those skilled in the art that any material that can generate vibration by collision with the protecting means 131 can be used.

On the other hand, the connecting means 143 is preferably provided when the magnetic force generating means 110 comprises four permanent magnets as shown in FIGS. 2 and 4. The connecting means 143 is preferably formed of non-magnetic material, and the second mobile object 140 is combined with the connecting means 143. At this point, the outer surface of the second mobile object 140 is preferably formed of pure iron material to flow magnetic fields and can be coated with chrome as needed.

As shown in FIGS. 1 and 2, the elastic means 150 according to a first embodiment of the present invention is combined with the protecting means 131 and the first mobile object 130, and thus the second mobile object 140 is fixed and the first mobile object 130 can be moved. On the other hand, as shown in FIGS. 3 and 4, the elastic means 150 is combined with the second mobile object 140 and the housing 160, and thus the first mobile object 130 is fixed and the second mobile object 140 can be moved.

The elastic means 150 preferably uses a spring or the like that can be returned to the original position by the restoring force although the first or second mobile object 130 or 140 is moved to one side by magnetic force. However, it is not limited thereto, but any material that can store elastic energy can be used. At this point, an appropriate resonant frequency can be set based on the coefficient of elasticity of the spring or the mass of the first or second mobile object 130 or 140, and if the first or second mobile object 130 or 140 is moved depending on the resonant frequency, strength of vibration generated by impact can be further intensified.

On the other hand, it is apparent that although the protecting means 131 and the limiter means 141 are not be provided, the electromagnetic force generating means 120 or the second mobile object 140 is combined with the elastic means 150, and vibration generated by inertia can be fed back.

The housing 160 according to a first embodiment of the present invention is combined with the elastic means 150 at one side as shown in FIGS. 3 and 4. An impact can be generated if the second mobile object 140 is moved since the housing 160 is combined with the elastic means 150, and the second mobile object 140 can be moved to the original position by the restoring force. The housing 160 is preferably formed of non-magnetic material.

### Motion of Vibration Generating Module According to First Embodiment

(Motion of First Mobile Object)

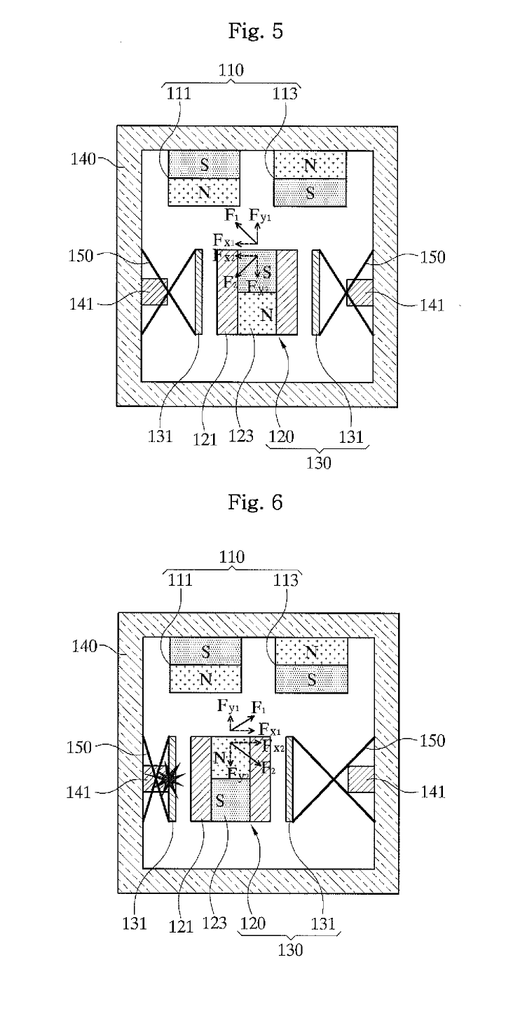

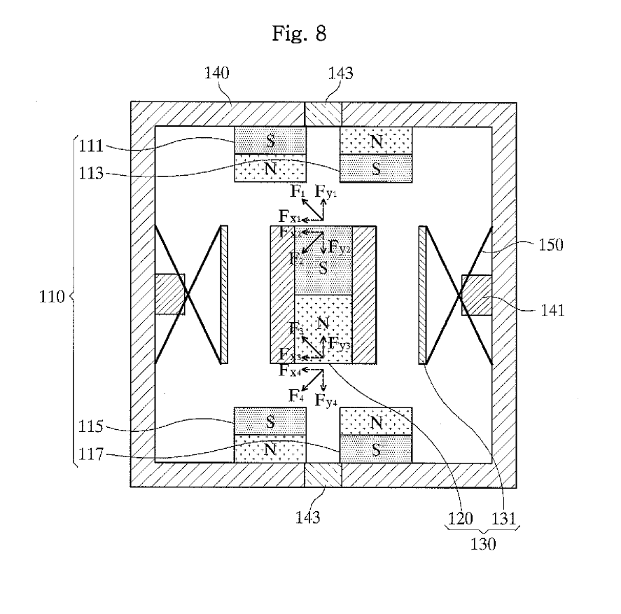

FIGS. 5 to 7 are views showing a concept of moving a first mobile object using two magnetic force generating means and an electromagnetic force generating means according to a first embodiment of the present invention, and FIGS. 8 to 10 are views showing a concept of moving a first mobile object using four magnetic force generating means and an electromagnetic force generating means according to a first embodiment of the present invention. Hereinafter, the motions of the first mobile object 130 according to a first embodiment of the present invention will be described with reference to FIGS. 5 to 10.

First, if current flows through the solenoid coil of the electromagnetic force generating means 120, electromagnetic fields are induced, and magnetic poles are formed at the iron core 123 provided inside the solenoid. The magnetic poles formed at this point can be changed depending on the direction of the current, and a control means 210 described below outputs a control signal for changing the direction of the current.

In the case where two magnetic force generating means 110 are used as shown in FIG. 5, if magnetic poles are formed at the iron core 123, attractive force F₁ is generated between the S-pole of the iron core 123 and the N-pole of the first magnetic force generating means 111, and repulsive force F₂ is generated between the S-pole of the iron core 123 and the S-pole of the second magnetic force generating means 113. If components of the attractive and repulsive forces are decomposed at this point, they can be decomposed into components of magnetic forces in the x-axis and y-axis directions. The y-axis components of the attractive and repulsive forces are offset each other, and only the components in the x-axis direction remain. The force of the components in the x-axis direction moves the first mobile object 130 to the left as shown in FIG. 6, and vibration is generated by the impact between the protecting means 131 and the limiter means 141. At this point, the vibration generated by the impact can be fed back.

However, if the elastic means 150 is combined with the electromagnetic force generating means 120 and the second mobile object 140, the electromagnetic force generating means 120 can generate vibration by inertia. Although the protecting means 131 and the limiter means 141 are not provided, the vibration generated by inertia can be fed back as the electromagnetic force generating means 120 is moved. Since the vibration generated by inertia can act hereinafter in the same manner as described above, it is not described, and vibration generated by impact will be described.

If the current applied to the electromagnetic force generating means 120 is removed when the first mobile object 130 has moved to the left, magnetic poles are not formed at the iron core 123. Accordingly, the first mobile object 130 returns to the original position by the restoring force of the elastic means 150.

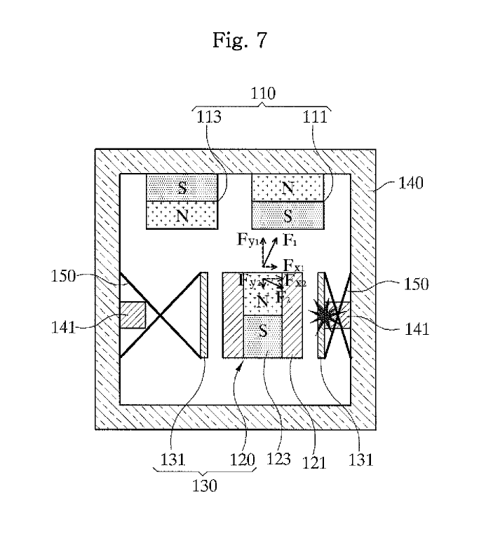

On the other hand, as shown in FIG. 6, if the magnetic poles of the iron core 123 are changed when the first mobile object 130 has moved to the left, repulsive force F₁ is generated between the N-pole of the iron core 123 and the N-pole of the first magnetic force generating means 111, and attractive force F₂ is generated between the N-pole of the iron core 123 and the S-pole of the second magnetic force generating means 113. If components of the attractive and repulsive forces are decomposed at this point, y-axis components of the attractive and repulsive forces are offset each other, and only the components in the x-axis direction remain. If force of the components in the x-axis direction moves the first mobile object 130 to the right as shown in FIG. 7, vibration is generated by the impact between the protecting means 131 and the limiter means 141. At this point, it is apparent that although the protecting means 131 and the limiter means 141 are not provided, vibration generated by inertia can be fed back as described above.

If the current applied to the electromagnetic force generating means 120 is removed when the first mobile object 130 has moved to the right, magnetic poles are not formed at the iron core 123. Accordingly, the first mobile object 130 returns to the original position by the restoring force of the elastic means 150.

In the case where four magnetic force generating means 110 are used as shown in FIG. 8, if magnetic poles are formed at the iron core 123, attractive force F₁ is generated between the S-pole of the iron core 123 and the N-pole of the first magnetic force generating means 111, and repulsive force F₂ is generated between the S-pole of the iron core 123 and the S-pole of the second magnetic force generating means 113. In addition, attractive force F₃ is generated between the N-pole of the iron core 123 and the S-pole of the third magnetic force generating means 115, and repulsive force F₄ is generated between the N-pole of the iron core 123 and the N-pole of the fourth magnetic force generating means 117.

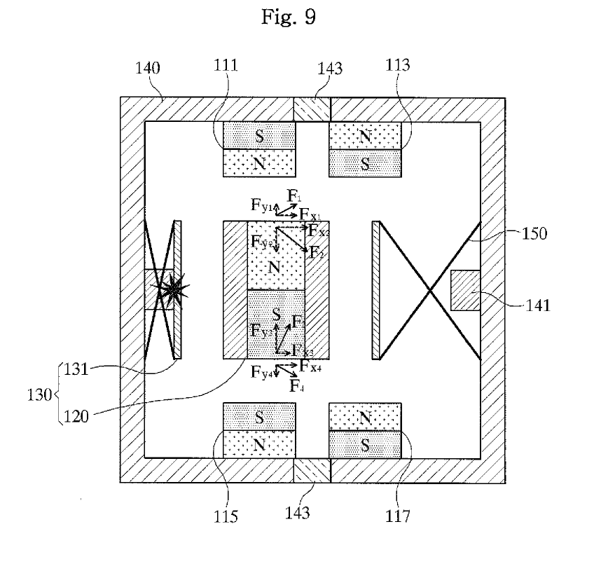

At this point, if components of the attractive and repulsive forces are decomposed, they can be decomposed into components of magnetic forces in the x-axis and y-axis directions. The y-axis components of the attractive and repulsive forces are offset each other, and only the components in the x-axis direction remain. If force of the components in the x-axis direction moves the first mobile object 130 to the left as shown in FIG. 9, vibration is generated by the impact between the protecting means 131 and the limiter means 141. At this point, it is apparent that although the protecting means 131 and the limiter means 141 are not provided, vibration generated by inertia can be fed back as described above.

Since the components of magnetic force in the x-axis direction generated using four permanent magnets are larger than those of magnetic force generated using two permanent magnets as described above, further stronger vibration can be generated.

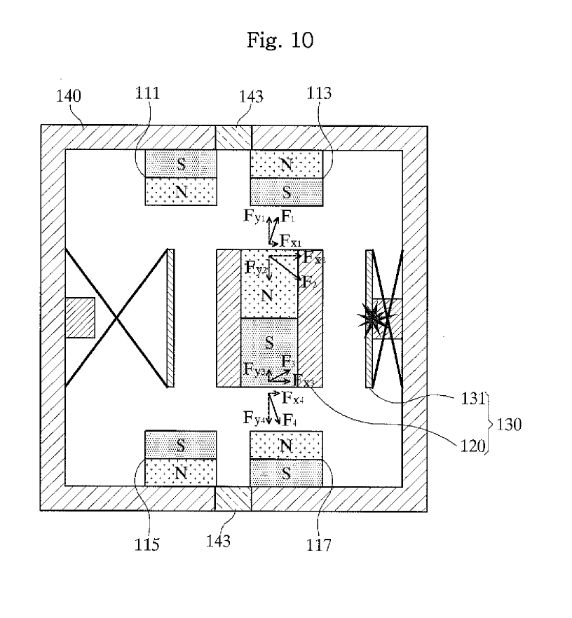

On the other hand, as shown in FIG. 9, if the magnetic poles of the iron core 123 are changed when the first mobile object 130 has moved to the left, repulsive force F₂ is generated between the N-pole of the iron core 123 and the N-pole of the first magnetic force generating means 111, and attractive force F₁ is generated between the N-pole of the iron core 123 and the S-pole of the second magnetic force generating means 113. In addition, repulsive force F₃ is generated between the S-pole of the iron core 123 and the S-pole of the third magnetic force generating means 115, and attractive force F₄ is generated between the S-pole of the iron core 123 and the N-pole of the fourth magnetic force generating means 117. The y-axis components of the attractive and repulsive forces are offset each other, and only components in the x-axis direction remain. If force of the components in the x-axis direction moves the first mobile object 130 to the right as shown in FIG. 10, vibration is generated by the impact between the protecting means 131 and the limiter means 141. At this point, it is apparent that although the protecting means 131 and the limiter means 141 are not provided, vibration generated by inertia can be fed back as described above.

(Motion of Second Mobile Object)

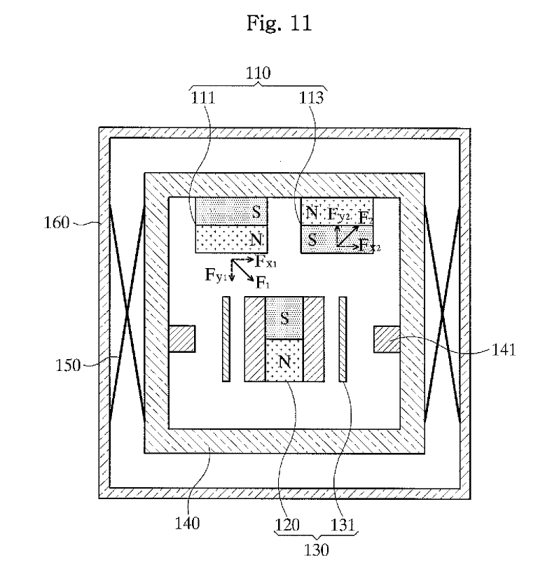

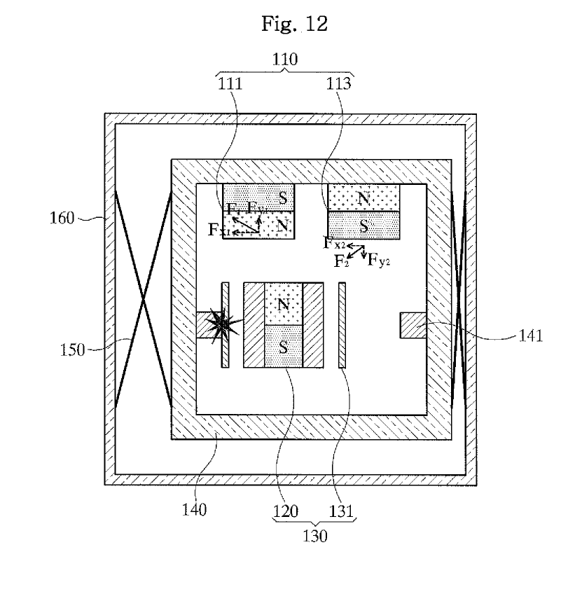

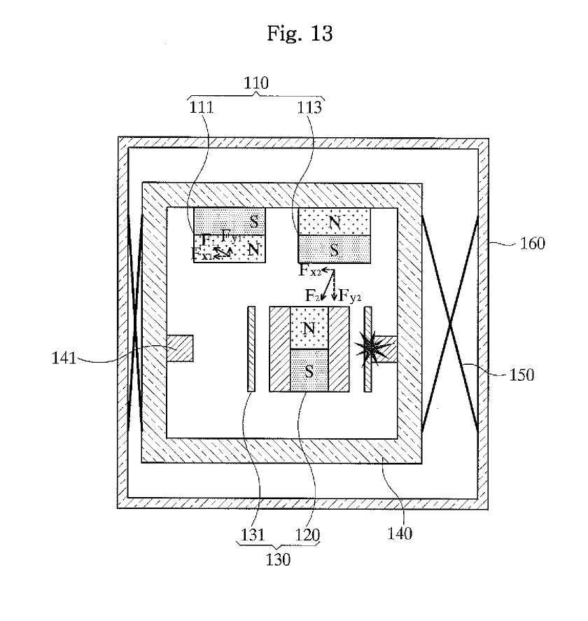

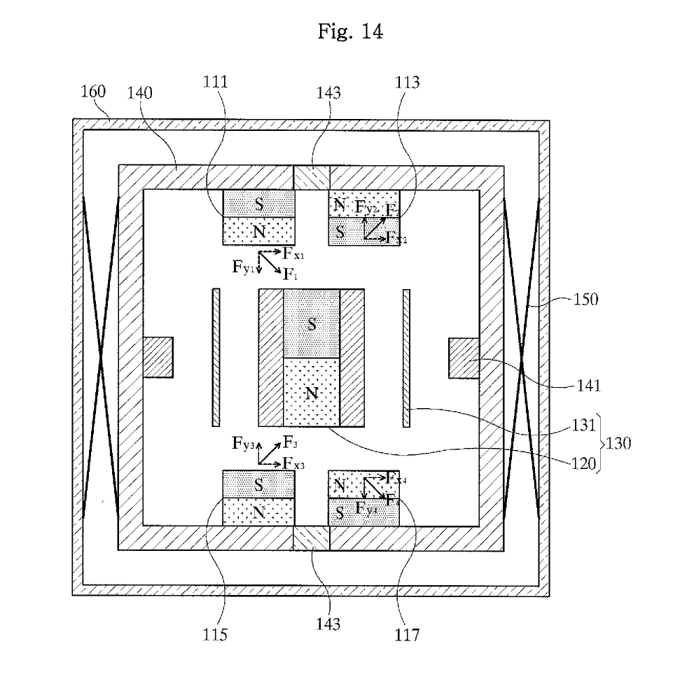

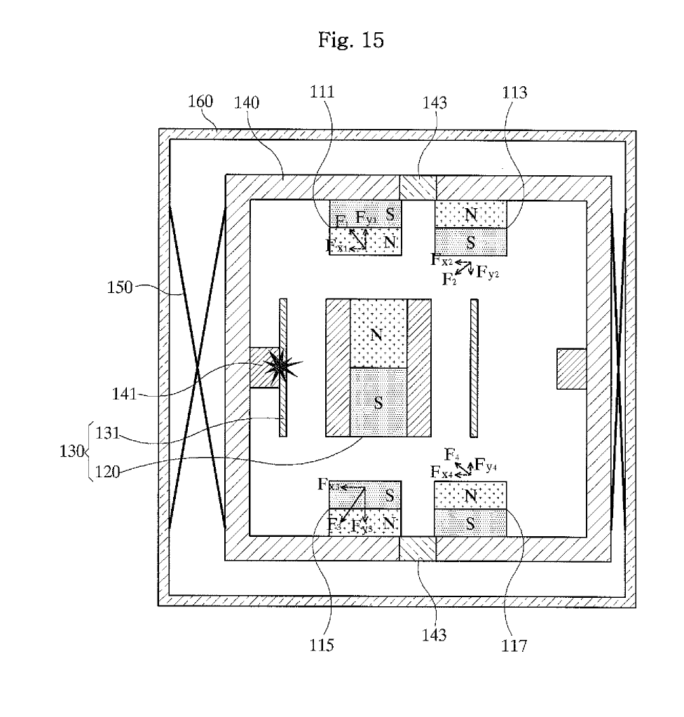

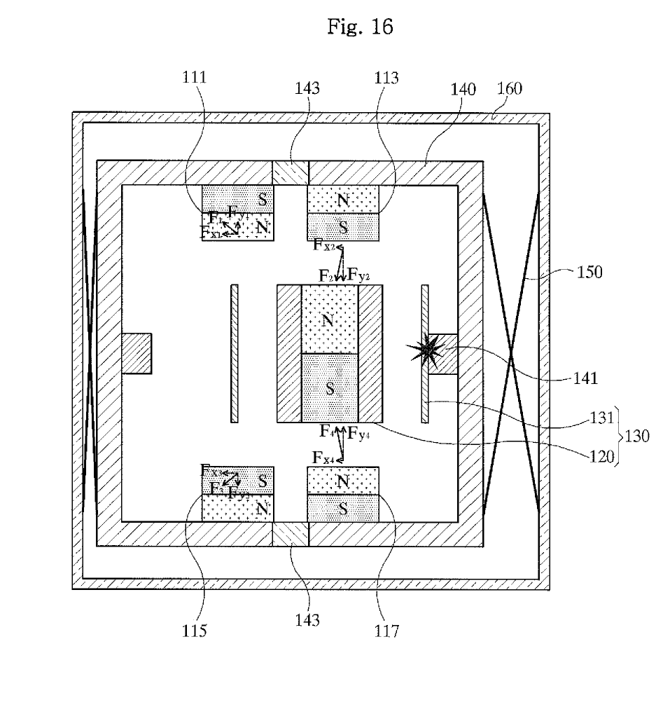

FIGS. 11 to 13 are views showing a concept of moving a second mobile object using two magnetic force generating means and an electromagnetic force generating means according to a first embodiment of the present invention, and FIGS. 14 to 16 are views showing a concept of moving a second mobile object using four magnetic force generating means and an electromagnetic force generating means according to a first embodiment of the present invention. Hereinafter, the motions of the second mobile object 140 according to a first embodiment of the present invention will be described with reference to FIGS. 11 to 16.

The second mobile object 140 is moved in the same manner as the first mobile object 130 described above. All the motions are the same other than that the second mobile object 140 can be moved and the first mobile object 130 is fixed, and the second mobile object 140 is moved by the attractive and repulsive forces of the magnetic force.

(Paths of Magnetic Fields)

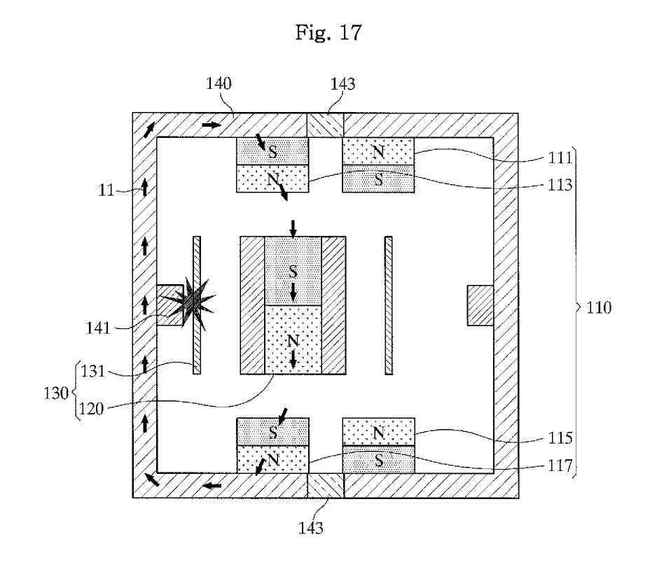

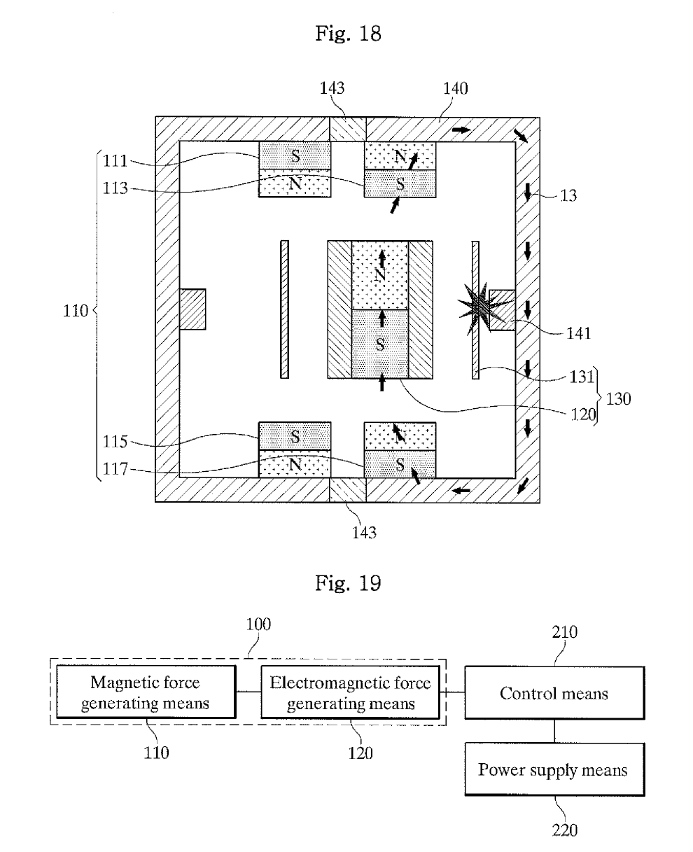

FIGS. 17 and 18 are views showing a magnetic path according to a first embodiment of the present invention.

The magnetic path according to a first embodiment of the present invention is formed when the magnetic force generating means 110 comprises four permanent magnets. Hereinafter, the magnetic path according to the present invention will be described.

A first magnetic path 11 shown in FIG. 17 is formed when a magnetic pole of the iron core 123 facing the N-pole of the first magnetic force generating means 111 is the S-pole, and the magnetic path formed as such flows along the outer surface of the second mobile object 140 by way of the solenoid and the third magnetic force generating means 115. At this point, since the connecting means 143 is formed of non-magnetic material, the magnetic fields flowing along the outer surface of the second mobile object 140 flow to the first magnetic force generating means 111 again and form the magnetic path.

On the other hand, a second magnetic path 13 shown in FIG. 18 is formed when a magnetic pole of the iron core 123 facing the S-pole of the second magnetic force generating means 113 is the N-pole, and the magnetic path is as shown in FIG. 18.

The magnetic paths described above are formed in order to reduce loss of magnetic force in comparison with a case where magnetic paths are not formed. Accordingly, the magnetic force formed between the permanent magnets and the solenoid is not lost, and further stronger magnetic force will be generated compared with the case where magnetic paths are not formed.

### Configuration of Actuator According to First Embodiment

FIG. 19 is a view showing the configuration of an actuator according to a first embodiment of the present invention. As shown in FIG. 19, the actuator according to a first embodiment of the present invention comprises a vibration generating module 100, a control means 210, and a power supply means 220. The aforementioned descriptions substitute for descriptions of the configuration of the vibration generating module 100, and the control means 210 and the power supply means 220 will be mainly described.

The control means 210 according to a first embodiment of the present invention outputs a magnetic pole change signal to the electromagnetic force generating means 120 of the vibration generating module 100. At this point, the magnetic pole change signal is a signal enabling the electromagnetic force generating means 120 to generate alternating electromagnetic force. The alternating electromagnetic force induces magnetic poles different from each other at the iron core 123.

The control means 210 can be implemented using an MCU, MPU, DSP, or the like and also can be implemented by designing an integrated circuit such as FPGA, ASIC or the like. It is apparent to those skilled in the art that a memory (not shown) for storing a program for driving the control means 210 is needed.

The power supply means 220 according to a first embodiment of the present invention is a means for supplying electricity to the electromagnetic force generating means 120 and the control means 210. Although either alternating voltage or direct voltage can be supplied as needed, the direct voltage is preferably supplied.

### Configuration of Handheld Device According to First Embodiment

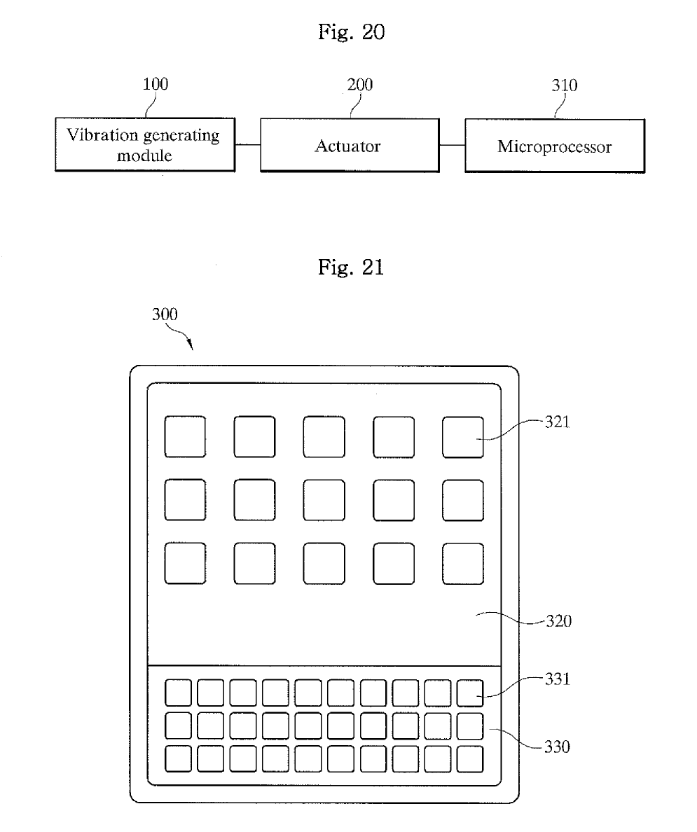

FIG. 20 is a view showing the configuration of a handheld device according to a first embodiment of the present invention, and FIG. 21 is a front view showing a handheld device according to a first embodiment of the present invention.

As shown in FIG. 20, the handheld device according to a first embodiment of the present invention may comprise a vibration generating module 100, an actuator 200, and a microprocessor 310. The aforementioned descriptions substitute for descriptions of the vibration generating module 100 and the actuator 200, and the microprocessor 310 will be mainly described hereinafter.

The microprocessor 310 according to a first embodiment of the present invention senses a state of the handheld device 300 and outputs a control signal to the control means 210 in order to provide a sense of touch delivered by vibration depending on the state of the handheld device 300. The control signal outputted to the control means 210 at this point induces magnetic poles formed at the iron core 123 of the electromagnetic force generating means 120 or changes the magnetic poles to each other.

On the other hand, as shown in FIG. 21, the state of the handheld device 300 may be a press on a touch screen 320, an icon 321 displayed on the touch screen 320, a press on a key 331 of a keypad 330 displayed on the touch screen 320, or generation of an event of the handheld device 300. At this point, the event of the handheld device 300 may be calling or receiving a phone call, receiving a character message, playing a game at the handheld device 300, taking a picture using the handheld device 300, or the like, and the vibration generating module 100 generates vibration corresponding to the event.

Accordingly, the microprocessor 310 having the functions described above can be implemented using an MCU, MPU, DSP, or the like or can be implemented by designing an integrated circuit such as FPGA, ASIC, or the like. It is apparent to those skilled in the art that a memory (not shown) for storing a program for driving the microprocessor 310 is needed.

### Vibration Generating Method According to First Embodiment

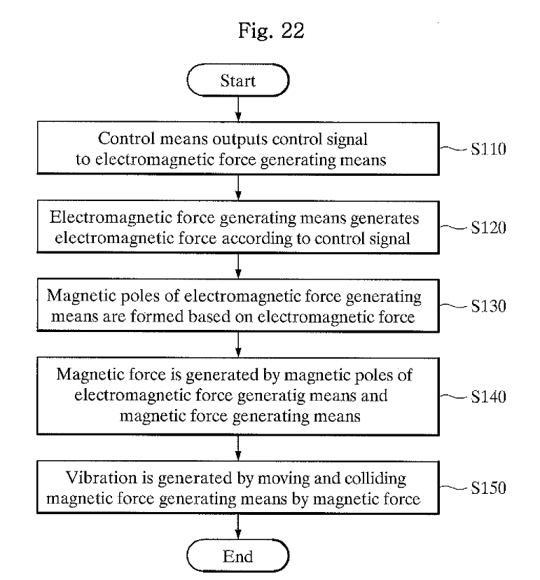

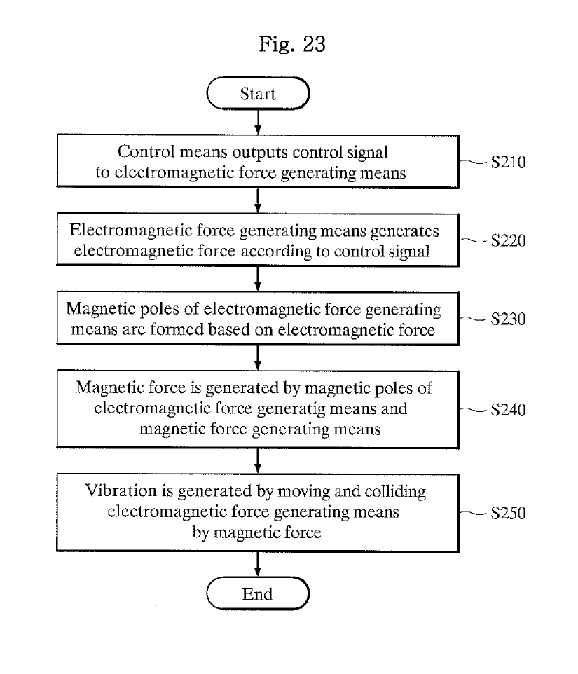

FIG. 22 is a flowchart sequentially illustrating a vibration generating method based on the movement of a magnetic force generating means according to a first embodiment of the present invention, and FIG. 23 is a flowchart sequentially illustrating a vibration generating method based on the movement of an electromagnetic force generating means according to a first embodiment of the present invention.

An embodiment of a vibration generating method that can be performed by the actuator 200 having the configuration described above is shown in FIGS. 22 and 23.

As shown in FIG. 22, a vibration generating method based on the movement of a magnetic force generating means according to a first embodiment of the present invention performs steps S110 to S150, and this will be described hereinafter with reference to FIG. 22.

First, the control means 210 outputs a control signal to the electromagnetic force generating means 120 S110. The control signal outputted at this point is a signal for forming magnetic poles at the iron core 123 of the electromagnetic force generating means 120. If current flows to the electromagnetic force generating means 120 according to the control signal, the magnetic poles are formed. In addition, if flow of the current is changed, the magnetic poles can be changed to each other.

Next, after performing step S110, the electromagnetic force generating means 120 generates electromagnetic force according to the control signal S120. At this point, the electromagnetic force is formed inside and outside of the solenoid.

Next, after performing step S120, magnetic poles are formed at the electromagnetic force generating means 120 S130. The magnetic poles can be changed to each other by the control signal of the control means 210 as needed.

Next, after performing step S130, magnetic force is generated by the magnetic poles of the electromagnetic force generating means 120 and the magnetic force generating means 110 S140. The magnetic force generated at this point is attractive force and repulsive force, and the attractive and repulsive forces are generated by opposing at least any one of the magnetic poles formed at the iron core 123 to a magnetic pole of the magnetic force generating means 110.

Finally, after performing step S140, vibration is generated as the magnetic force generating means 110 is moved by the magnetic force and collides with a protecting means S150.

On the other hand, steps S110 to S140 of the vibration generating method based on the movement of an electromagnetic force generating means are the same as described above. Then, vibration is generated as the electromagnetic force generating means 120 is moved and collided by the electromagnetic force S250. At this point, the magnetic force generating means 110 does not move and is fixed, and the vibration generating method can be performed by moving the electromagnetic force generating means 120.

### Configuration of Vibration Generating Module According to Second Embodiment

(Configuration of Vibration Generating Module Based on Inertia)

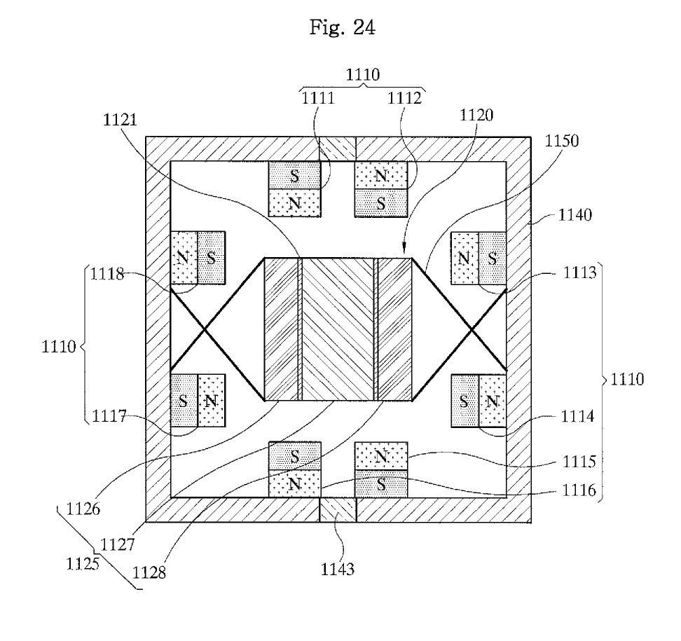

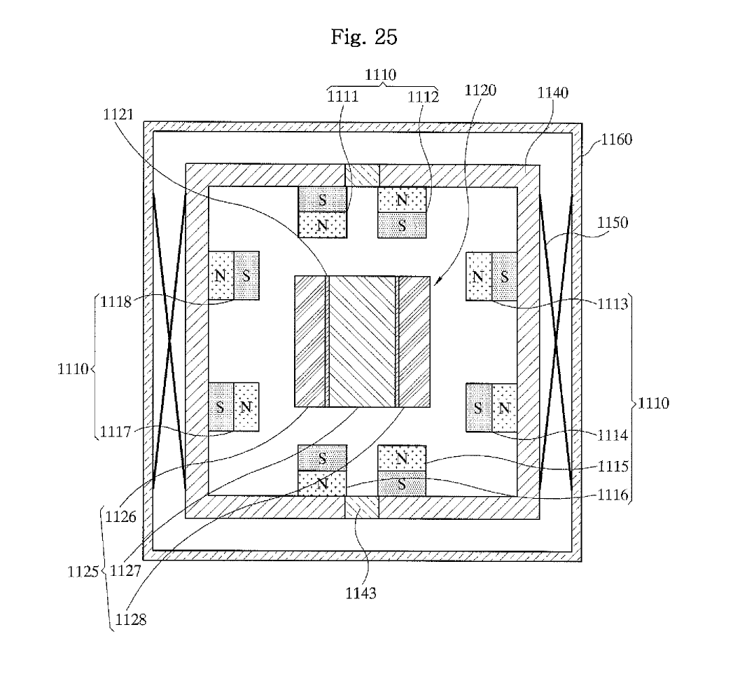

FIGS. 24 and 25 are views showing a configuration of generating vibration by inertia according to a second embodiment of the present invention. FIG. 24 is a view showing a configuration where an elastic means of a vibration generating module is combined with an electromagnetic force generating means according to a second embodiment of the present invention, and FIG. 25 is a view showing a configuration where an elastic means of a vibration generating module is combined with a second mobile object according to a second embodiment of the present invention.

As shown in FIGS. 24 and 25, a vibration generating module using an unstable structure according to a second embodiment of the present invention may comprise a magnetic force generating means 1110 and an electromagnetic force generating means 1120, and preferably further comprises a second mobile object 1140, elastic means 1150, and a housing 1160. Hereinafter, the configuration of the vibration generating module according to a second embodiment of the present invention will be described with reference to FIGS. 24 and 25.

First, the unstable structure is defined in the present invention. In an initial state before current is applied to the electromagnetic force generating means 1120, the magnetic force generating means 1110 and the electromagnetic force generating means 1120 are not affected by magnetic force of each other, and thus the magnetic force generating means 1110 and the electromagnetic force generating means 1120 do not move.

If a disturbance is applied in this initial state, i.e., if current is applied to the electromagnetic force generating means 1120, magnetic poles are formed at the electromagnetic force generating means 1120, and the magnetic force generating means 1110 or the electromagnetic force generating means 1120 is affected by magnetic force of each other and moved to the left or right.

The magnetic force generating means 1110 according to a second embodiment of the present invention is a means for generating magnetic force using permanent magnets, and the magnetic force is generated by opposing magnetic poles formed at the magnetic force generating means 1110 to magnetic poles formed at the electromagnetic force generating means 1120. As shown in FIGS. 24 and 25, the magnetic force generating means 1110 may be provided with eight permanent magnets. Accordingly, the eight permanent magnets should be formed such that magnetic poles facing each other are magnetic poles different from each other.

That is, if either of the facing magnetic poles of a first magnetic force generating means 1111 and a second magnetic force generating means 1112 is the S-pole, the opposing magnetic pole should be the N-pole, and it is the same for a fifth magnetic force generating means 1115 and a sixth magnetic force generating means 1116. In addition, if either of the facing magnetic poles of the first and sixth magnetic force generating means 1111 and 1116 is the S-pole, the opposing magnetic pole should be the N-pole, and it is the same for the second and fifth magnetic force generating means 1112 and 1115.

In addition, if either of the facing magnetic poles of the third and fourth magnetic force generating means 1113 and 1114 is the S-pole, the opposing magnetic pole should be the N-pole, and it is the same for a seventh magnetic force generating means 1117 and an eighth magnetic force generating means 1118. In addition, if either of facing magnetic poles of the third and eighth magnetic force generating means 1113 and 1118 is the S-pole, the opposing magnetic pole should be the N-pole, and it is the same for the fourth and seventh magnetic force generating means 1114 and 1117.

On the other hand, if the magnetic force generating means 1110 described above is provided with eight permanent magnets, unnecessary components of magnetic force in the y-axis direction can be offset to the maximum, and magnetic force in the x-axis direction can be increased. In addition, since a local magnetic path 10A is formed by the magnetic force generating means 1110 and the electromagnetic force generating means 1120, initial magnetic force can be further increased.

The electromagnetic force generating means 1120 according to a second embodiment of the present invention is a means for generating electromagnetic force alternating depending on a magnetic pole change signal. The electromagnetic force generating means 1120 generates magnetic fields using a solenoid and is provided with a second iron core 1127 inside. The electromagnetic force generating means 1120 can generate further stronger magnetic fields by winding a solenoid coil 1121. Since strength of the magnetic fields at the solenoid is proportional to the number of turns of the coil and strength of current, the number of turns of the coil needs to be increased in order to increase the strength of the magnetic fields.

On the other hand, as shown in FIGS. 24 and 25, the solenoid coil 1121 of the electromagnetic force generating means 1120 winds the second iron core 1127, and a first iron core 1126 and a third iron core 1128 are preferably provided at both sides of the solenoid coil 1121.

Since magnetic poles are formed at the first, second, and third iron cores 1126, 1127, and 1128, magnetic force lines are formed at the electromagnetic force generating means 1120 as current is applied to the electromagnetic force generating means 1120, and magnetic poles are formed at the second iron core 1127 as the magnetic force lines are formed inside the solenoid. Then, magnetic poles are formed at the first and third iron cores 1126 and 1128 provided on both sides of the solenoid coil 1121, by the magnetic force lines formed outside the solenoid.

It is preferable to provide the first, second, and third iron cores 1126, 1127, and 1128 and the solenoid coil 1121 winding the second iron core 1127 as shown in FIGS. 24 and 25. Three pairs of magnetic poles can be formed by the iron core 1125 and the solenoid coil 1121.

On the other hand, the three pairs of magnetic poles formed at the electromagnetic force generating means 1120 are magnetic poles alternating by a control means 1210 described below, and the alternating three pairs of magnetic poles are opposed to the magnetic poles of the magnetic force generating means 1110, and thus magnetic force is generated and starts to act.

A second mobile object 1140 according to a second embodiment of the present invention comprises a plurality of magnetic force generating means 1110 inside, and preferably further comprises a connecting means 1143. At this point, the outer surface of the second mobile object 1140 is preferably formed of pure iron material to flow magnetic fields and can be coated with chrome as needed.

On the other hand, an elastic means 1150 described below can be combined with the second mobile object 1140 or the electromagnetic force generating means 1120 as needed.

On the other hand, the connecting means 1143 is formed preferably using silicon material, i.e., non-magnetic material, so that a local magnetic path can be formed. However, it is not limited to silicon, but any material that can form the local magnetic path and is connect to the second mobile objects 1140 can be used.

As shown in FIG. 24, the elastic means 1150 according to a second embodiment of the present invention is combined with the electromagnetic force generating means 1120 and the second mobile object 1140, and thus the second mobile object 1140 is fixed and the electromagnetic force generating means 1120 can be moved. On the other hand, as shown in FIG. 25, the elastic means 1150 is combined with the second mobile object 1140 and the housing 1160, and thus the electromagnetic force generating means 1120 is fixed and the second mobile object 1140 can be moved.

The elastic means 1150 preferably uses a spring or the like that can be returned to the original position by the restoring force although the electromagnetic force generating means 1120 or the second mobile object 1140 is moved to one side by magnetic force. However, it is not limited thereto, but any material that can store elastic energy can be used.

At this point, an appropriate resonant frequency can be set based on the coefficient of elasticity of the spring or the mass of the electromagnetic force generating means 1120 or the second mobile object 1140, and if the electromagnetic force generating means 1120 or the second mobile object 1140 is moved depending on the resonant frequency, strength of vibration generated by impact can be further intensified.

The housing 1160 according to a second embodiment of the present invention is combined with the elastic means 1150 at one side when the second mobile object 1140 is moved. An impact can be generated if the second mobile object 1140 is moved since the housing 1160 is combined with the elastic means 1150, and the second mobile object 1140 can be moved to the original position by the restoring force. Although the housing 1160 is preferably formed of synthetic resin material, i.e., non-magnetic material, it is not limited to the synthetic resin material.

(Configuration of Vibration Generating Module Based on Collision)

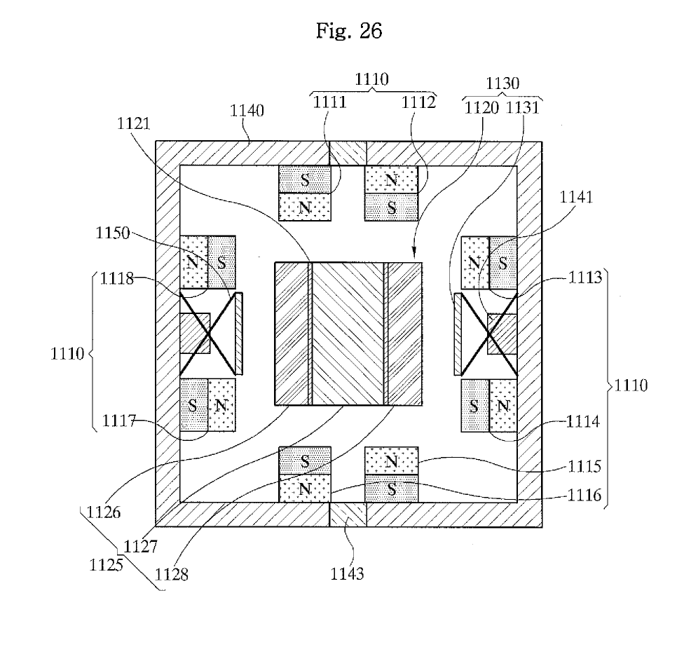

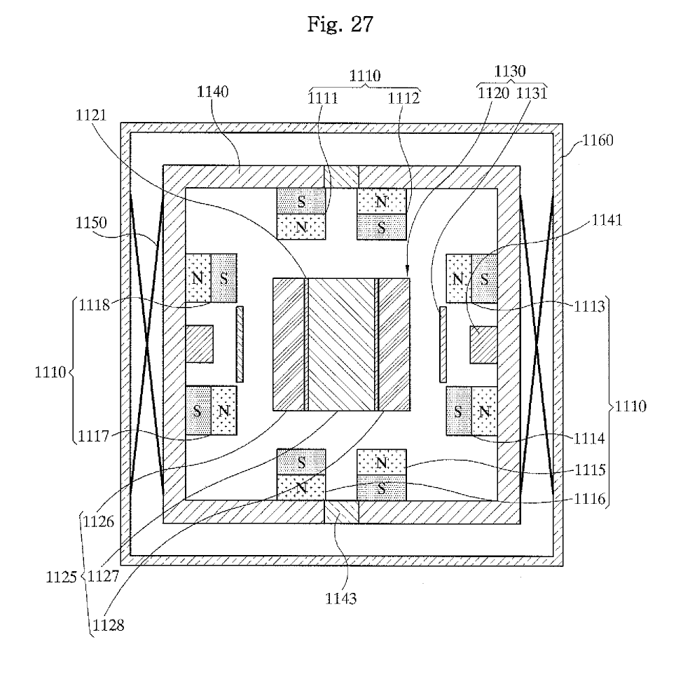

FIGS. 26 and 27 are views showing a configuration of generating vibration by impact according to a second embodiment of the present invention. FIG. 26 is a view showing a configuration where an elastic means of a vibration generating module is combined with a first mobile object according to a second embodiment of the present invention, FIG. 27 is a view showing a configuration where an elastic means of a vibration generating module is combined with a second mobile object according to a second embodiment of the present invention.

As shown in FIGS. 26 and 27, a vibration generating module according to a second embodiment of the present invention may comprise a magnetic force generating means 1110 and an electromagnetic force generating means 1120, and preferably further comprises a first mobile object 1130, a second mobile object 1140, elastic means 1150, and a housing 1160.

Hereinafter, the configuration of the vibration generating module according to a second embodiment of the present invention will be described with reference to FIGS. 26 and 27. However, the aforementioned descriptions substitute for descriptions of the configuration, and a protecting means 1131 included in the first mobile object 1130 and a limiter means 1141 included in the second mobile object 1140 will be additionally described.

The first mobile object 1130 according to a second embodiment of the present invention preferably comprises a protecting means 1131 and an electromagnetic force generating means 1120. Since the electromagnetic force generating means 1120 is the same as described above, the aforementioned descriptions substitute for descriptions thereof, and the protecting means 1131 will be described hereinafter.

In the second embodiment of the present invention, two protecting means 1131 are provided, and the protecting means 1131 are respectively combined with a first iron core 1126 and a third iron core 1128. However, the protecting means 1131 are not limited by two, but it is apparent that the protecting means 1131 can be provided in plurality of two or more.

In addition, the protecting means 1131 collides with the limiter means 1141 described below and protects the electromagnetic force generating means 1120 from impact when vibration is generated by the impact. Accordingly, although the protecting means 1131 is preferably formed of non-magnetic material such as silicon or the like to protect the electromagnetic force generating means 1120 from the impact, it is apparent to those skilled in the art that it is not limited only to the silicon.

The second mobile object 1140 according to a second embodiment of the present invention preferably comprises a plurality of magnetic force generating means 1110, connecting means 1143, and limiter means 1141. The aforementioned descriptions substitute for descriptions of the magnetic force generating means 1110 and the connecting means 1143, and the limiter means 1141 will be described hereinafter.

The limiter means 1141 are provided at both inner sides of the second mobile object 1140, limits the range of movement of the first or second mobile object 1130 or 1140, and generates vibration by collision with the protecting means 1131. Although the limiter means 1141 can be formed of silicon, it is not limited thereto, and it is apparent to those skilled in the art that any material that can generate vibration by collision with the protecting means 1131 can be used.

### Motion of Vibration Generating Module According to Second Embodiment

(Motion of First Mobile Object)

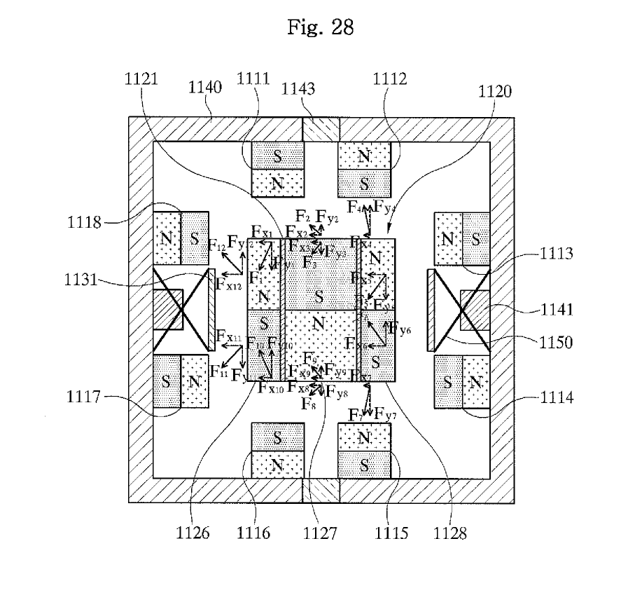

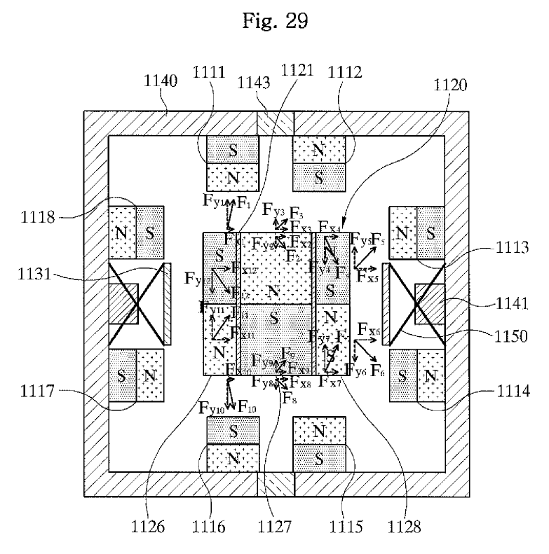

FIG. 28 is a view showing a concept of moving an electromagnetic force generating means or a first mobile object of a vibration generating module to the left according to a second embodiment of the present invention, and FIG. 29 is a view showing a concept of moving an electromagnetic force generating means or a first mobile object of a vibration generating module to the right according to a second embodiment of the present invention. Hereinafter, the motions of the first mobile object 1130 according to a second embodiment of the present invention will be described with reference to FIGS. 28 and 29.

First, if current flows through a solenoid coil 1121 of the electromagnetic force generating means 1120, electromagnetic fields are induced, and magnetic poles are formed at the iron core 1125 provided inside the solenoid. The magnetic poles formed at this point can be changed depending on the direction of the current, and a control means 1210 described below outputs a control signal for changing the direction of the current.

As shown in FIGS. 24 to 27, if magnetic poles are not formed at the electromagnetic force generating means 1120, magnetic force interacting between the electromagnetic force generating means 1120 and the magnetic force generating means 1110 is not formed, and thus the first mobile object 1130 including the electromagnetic force generating means 1120 does not move and maintains the initial state.

As shown in FIG. 28, if three pairs of magnetic poles are formed as current is applied to the electromagnetic force generating means 1120, repulsive force F₁ is generated between the N-pole of the first iron core 1126 and the N-pole of the first magnetic force generating means 1111, and attractive force F₄ is generated between the N-pole of the third iron core 1128 and the S-pole of the second magnetic force generating means 1112.

In addition, attractive force F₂ is generated between the S-pole of the second iron core 1127 and the N-pole of the first magnetic force generating means 1111, and repulsive force F₃ is generated between the S-pole of the second iron core 1127 and the S-pole of the second magnetic force generating means 1112.

On the other hand, repulsive force F₅ is generated between the N-pole of the third iron core 1128 and the N-pole of the third magnetic force generating means 1113, and repulsive force F₆ is generated between the S-pole of the third iron core 1128 and the S-pole of the fourth magnetic force generating means 1114.

In the same concept as described above, attractive and repulsive forces of F₇ to F₁₂ are generated as shown in FIG. 28. At this point, the attractive and repulsive forces can be decomposed into components of magnetic force in the x-axis and y-axis directions. The y-axis components of the attractive and repulsive forces are offset each other, and only the components in the x-axis direction remain. The force of the components in the x-axis direction moves the first mobile object 1130 to the left, and vibration is generated by the impact between the protecting means 1131 and the limiter means 1141. At this point, the vibration generated by the impact can be fed back.

On the other hand, if the protecting means 1131 and the limiter means 1141 are not provided, the elastic means 1150 is combined with the electromagnetic force generating means 1120 and the second mobile object 1140, and vibration generated by inertia as the electromagnetic force generating means 1120 is moved by the magnetic force described above can be fed back. Since the vibration generated by inertia can act hereinafter in the same manner as described above, it is not described, and vibration generated by impact will be described.

If the current applied to the electromagnetic force generating means 1120 is removed when the first mobile object 1130 has moved to the left, magnetic poles are not formed at the iron core 1125. Accordingly, the first mobile object 1130 returns to the original position by the restoring force of the elastic means 1150.

On the other hand, as shown in FIG. 29, if the magnetic poles formed at the electromagnetic force generating means 1120 are different from the magnetic poles shown in FIG. 28, attractive force F₁ is generated between the S-pole of the first iron core 1126 and the N-pole of the first magnetic force generating means 1111, and repulsive force F₄ is generated between the S-pole of the third iron core 1128 and the S-pole of the second magnetic force generating means 1112.

In addition, repulsive force F₂ is generated between the N-pole of the second iron core 1127 and the N-pole of the first magnetic force generating means 1111, and attractive force F₃ is generated between the N-pole of the second iron core 1127 and the S-pole of the second magnetic force generating means 1112.

On the other hand, attractive force F₅ is generated between the S-pole of the third iron core 1128 and the N-pole of the third magnetic force generating means 1113, and attractive force F₆ is generated between the N-pole of the third iron core 1128 and the S-pole of the fourth magnetic force generating means 1114.

In the same concept as described above, attractive and repulsive forces of F₇ to F₁₂ are generated as shown in FIG. 29. At this point, the attractive and the repulsive forces can be decomposed into components of magnetic force in the x-axis and y-axis directions. The y-axis components of the attractive and repulsive forces are offset each other, and only the components in the x-axis direction remain. The force of the components in the x-axis direction moves the first mobile object 1130 to the right, and vibration is generated by the impact between the protecting means 1131 and the limiter means 1141. At this point, the vibration generated by the impact can be fed back.

At this point, it is apparent that although the protecting means 1131 and the limiter means 1141 are not provided, vibration generated by inertia as the electromagnetic force generating means 1120 is moved can be fed back as described above.

If the current applied to the electromagnetic force generating means 1120 is removed when the first mobile object 1130 has moved to the right, magnetic poles are not formed at the iron core 1125. Accordingly, the first mobile object 1130 returns to the original position by the restoring force of the elastic means 1150.

(Motion of Second Mobile Object)

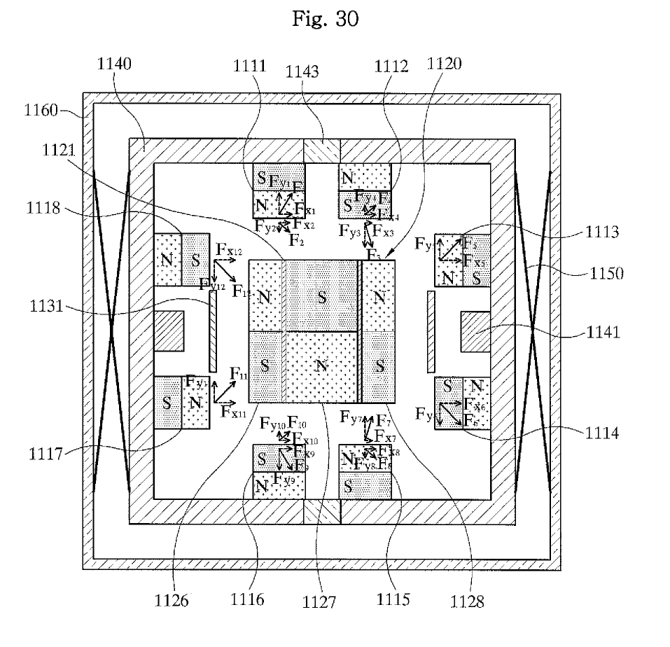

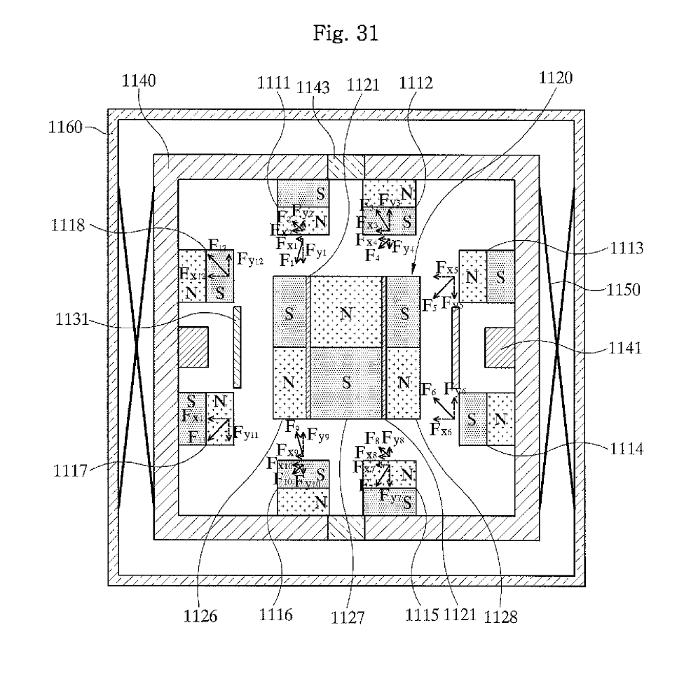

FIG. 30 is a view showing a concept of moving a second mobile object of a vibration generating module to the right according to a second embodiment of the present invention, and FIG. 31 is a view showing a concept of moving a second mobile object of a vibration generating module to the left according to a second embodiment of the present invention. Hereinafter, the motions of the second mobile object 1140 according to a second embodiment of the present invention will be described with reference to FIGS. 30 and 31.

The second mobile object 1140 is moved in the same manner as the first mobile object 1130 described above. All the motions are the same other than that the second mobile object 1140 can be moved and the first mobile object 1130 is fixed, and the second mobile object 1140 is moved by the attractive and repulsive forces of the magnetic force.

At this point, it is apparent that although the protecting means 1131 and the limiter means 1141 are not provided, vibration generated by inertia as the second mobile object 1140 is moved can be fed back as described above.

(Paths of Magnetic Fields)

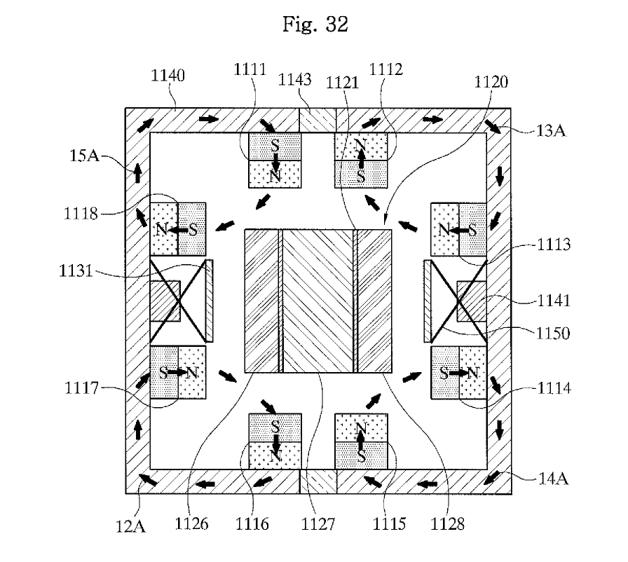

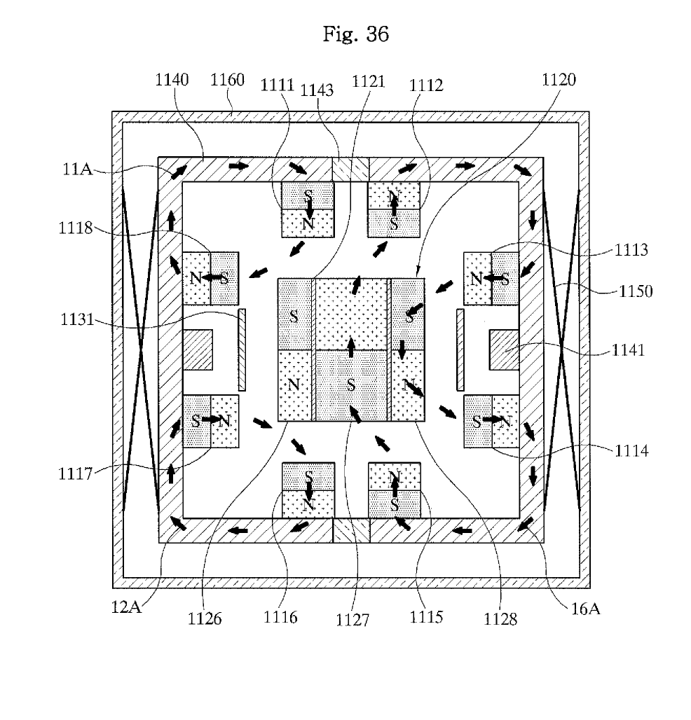

FIGS. 32 to 36 are views showing local magnetic paths. Hereinafter, the local magnetic paths will be described with reference to FIGS. 32 to 36.

As shown in FIG. 32, if magnetic poles are not formed at the electromagnetic force generating means 1120, a first, a second, a third, and a fourth local magnetic paths 11A to 14A are formed. Since the local magnetic path 10A may increase initial magnetic force, magnetic force interacting between the magnetic force generating means 1110 and the electromagnetic force generating means 1120 can be maximized.

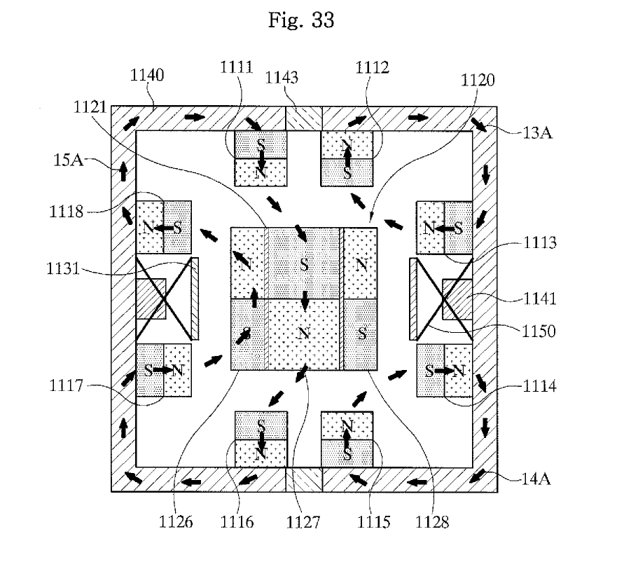

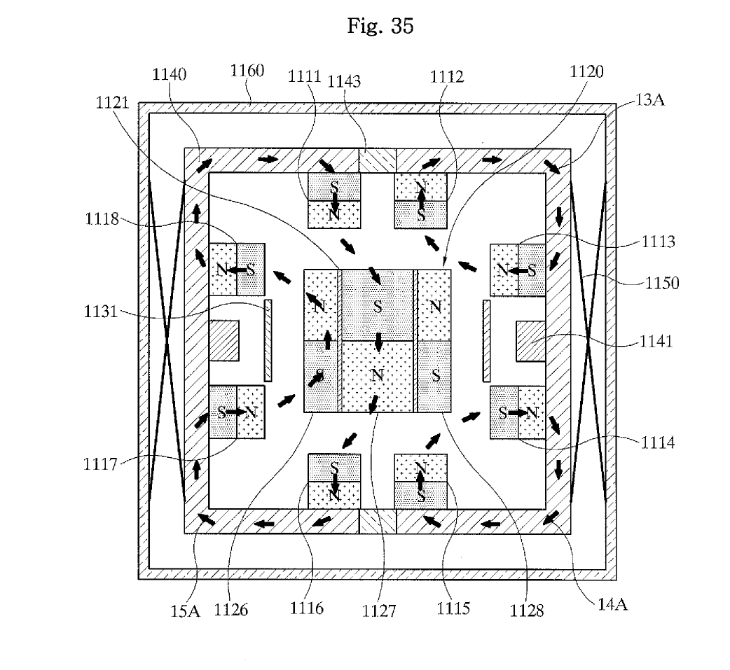

At this point, if magnetic poles shown in FIGS. 33 and 35 are formed at the iron core 1125, the third and fourth local magnetic paths 13A and 14A are not changed, and the first and second local magnetic paths 11A and 12A are changed to a fifth local magnetic path 15A.

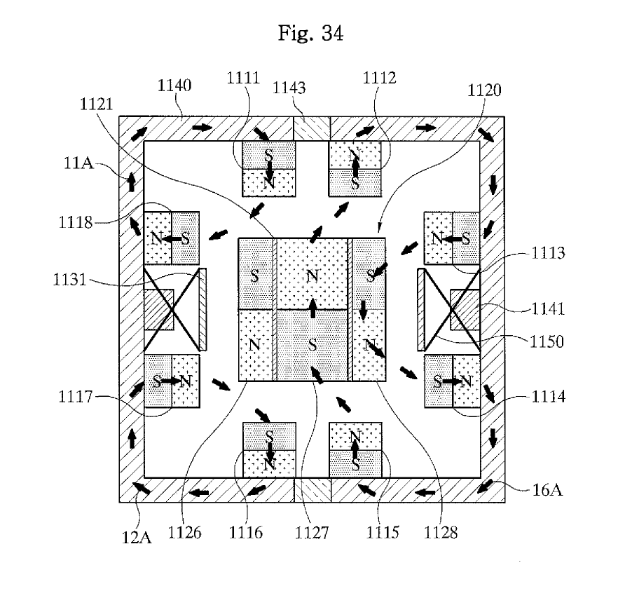

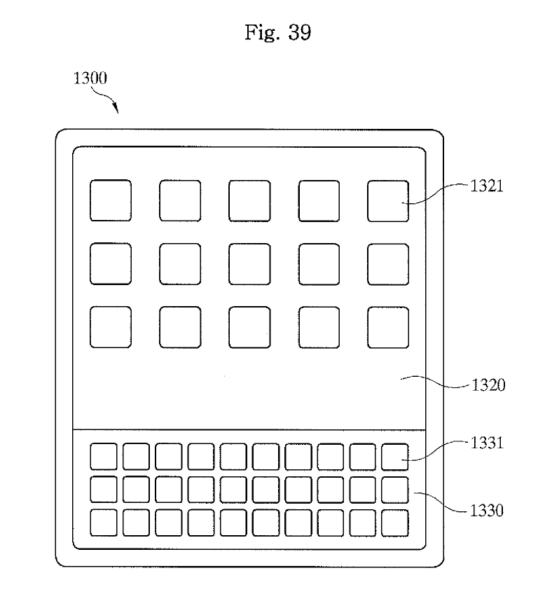

On the other hand, if magnetic poles shown in FIGS. 34 and 39 are formed at the iron core 1125, the first and second local magnetic paths 11A and 12A are not changed, and the third and fourth local magnetic paths 13A and 14A are changed to a sixth local magnetic path 16A.

The magnetic paths described above are formed in order to reduce loss of magnetic force in comparison with a case where magnetic paths are not formed. Accordingly, the magnetic force formed between the permanent magnets and the solenoid is not lost, and further stronger magnetic force will be generated compared with the case where magnetic paths are not formed.

### Configuration of Actuator According to Second Embodiment

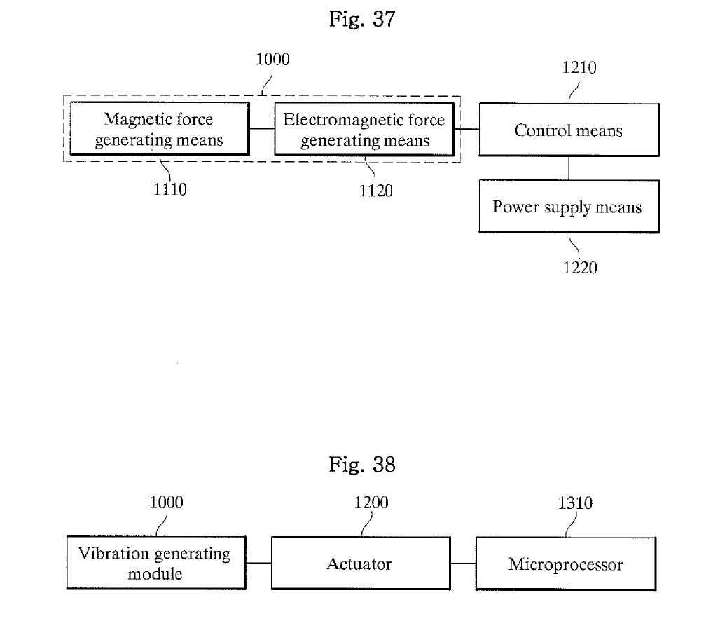

FIG. 37 is a view showing the configuration of an actuator according to a second embodiment of the present invention. As shown in FIG. 37, the actuator according to a second embodiment of the present invention comprises a vibration generating module 1100, a control means 1210, and a power supply means 1220. The aforementioned descriptions substitute for descriptions of the configuration of the vibration generating module 1100, and the control means 1210 and the power supply means 1220 will be mainly described.

The control means 1210 according to a second embodiment of the present invention outputs a magnetic pole change signal to the electromagnetic force generating means 1120 of the vibration generating module 1100. At this point, the magnetic pole change signal is a signal enabling the electromagnetic force generating means 1120 to generate alternating electromagnetic force. The alternating electromagnetic force induces magnetic poles different from each other at the iron core 1125.

The control means 1210 can be implemented using an MCU, MPU, DSP, or the like, and also can be implemented by designing an integrated circuit such as FPGA, ASIC, or the like. It is apparent to those skilled in the art that a memory (not shown) for storing a program for driving the control means 1210 is needed.

The power supply means 1220 according to a second embodiment of the present invention is a means for supplying electricity to the electromagnetic force generating means 1120 and the control means 1210. Although either alternating voltage or direct voltage can be supplied as needed, the direct voltage is preferably supplied.

### Configuration of Handheld Device According to Second Embodiment

FIG. 38 is a view showing the configuration of a handheld device according to a second embodiment of the present invention, and FIG. 39 is a front view showing a handheld device according to a second embodiment of the present invention.

As shown in FIG. 38, the handheld device according to a second embodiment of the present invention may comprise a vibration generating module 1100, an actuator 1200, and a microprocessor 1310. The aforementioned descriptions substitute for descriptions of the vibration generating module 1100 and the actuator 1200, and the microprocessor 1310 will be mainly described hereinafter.

The microprocessor 1310 according to a second embodiment of the present invention senses a state of the handheld device 1300 and outputs a control signal to the control means 1210 in order to provide a sense of touch delivered by vibration depending on the state of the handheld device 1300. The control signal outputted to the control means 1210 at this point induces magnetic poles formed at the iron core 1125 of the electromagnetic force generating means 1120 or changes the magnetic poles with each other.

On the other hand, as shown in FIG. 39, the state of the handheld device 1300 may be a press on a touch screen 1320, an icon 1321 displayed on the touch screen 1320, a press on a key 331 of a keypad 1330 displayed on the touch screen 1320, or generation of an event of the handheld device 1300. At this point, the event of the handheld device 1300 may be calling or receiving a phone call, receiving a character message, playing a game at the handheld device 1300, taking a picture using the handheld device 1300, or the like, and the vibration generating module 1100 generates vibration corresponding to the event.

Accordingly, the microprocessor 1310 having the functions described above can be implemented using an MCU, MPU, DSP, or the like or can be implemented by designing an integrated circuit such as FPGA, ASIC, or the like. It is apparent to those skilled in the art that a memory (not shown) for storing a program for driving the microprocessor 1310 is needed.

### Vibration Generating Method According to Second Embodiment

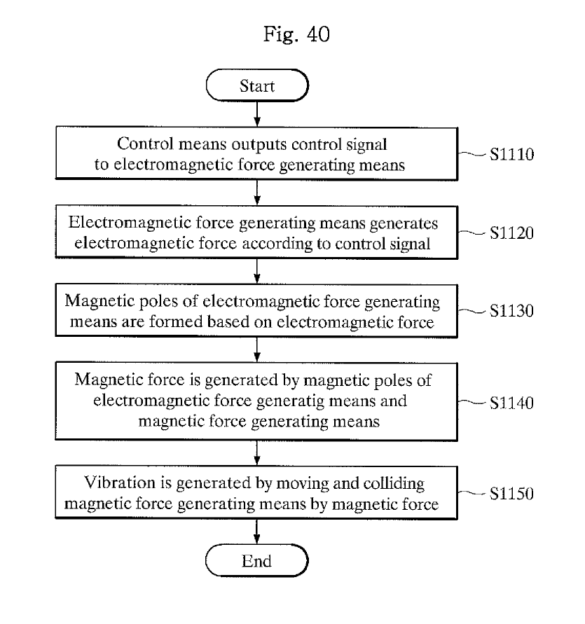

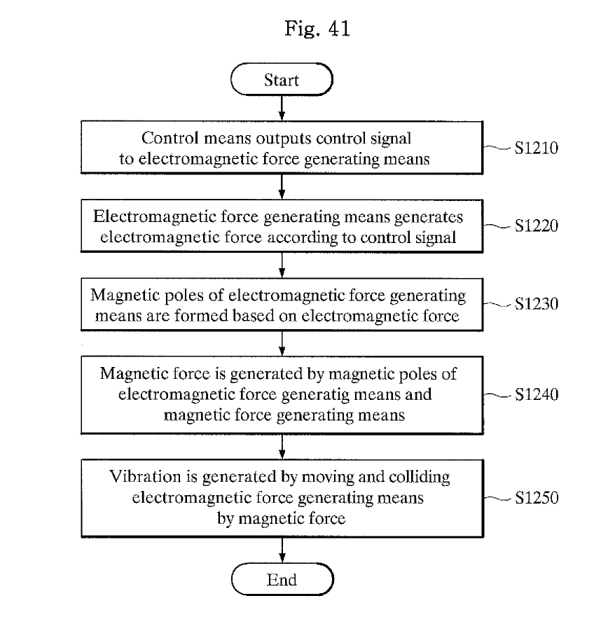

FIG. 40 is a flowchart sequentially illustrating a vibration generating method based on the movement of a magnetic force generating means according to a second embodiment of the present invention, and FIG. 41 is a flowchart sequentially illustrating a vibration generating method based on the movement of an electromagnetic force generating means according to a second embodiment of the present invention.

An embodiment of a vibration generating method that can be performed by the actuator 1200 having the configuration described above is shown in FIGS. 40 and 41.

As shown in FIG. 40, a vibration generating method based on the movement of a magnetic force generating means according to a second embodiment of the present invention performs steps S1110 to S1150, and this will be described hereinafter with reference to FIG. 40.

First, the control means 1210 outputs a control signal to the electromagnetic force generating means 1120 S1110. The control signal outputted at this point is a signal for forming magnetic poles at the iron core 1125 of the electromagnetic force generating means 1120. If current flows to the electromagnetic force generating means 1120 according to the control signal, the magnetic poles are formed. In addition, if flow of the current is changed, the magnetic poles can be changed to each other.

Next, after performing step S1110, the electromagnetic force generating means 1120 generates electromagnetic force according to the control signal S1120. At this point, the electromagnetic force is formed inside and outside of the solenoid.

Next, after performing step S1120, magnetic poles are formed at the electromagnetic force generating means 1120 S1130. The magnetic poles can be changed to each other by the control signal of the control means 1210 as needed.

Next, after performing step S1130, magnetic force is generated by the magnetic poles of the electromagnetic force generating means 1120 and the magnetic force generating means 1110 S1140. The magnetic force generated at this point is attractive force and repulsive force, and the attractive and repulsive forces are generated by opposing three pairs of magnetic poles formed at the iron core 1125 to the magnetic poles of the magnetic force generating means 1110.

Finally, after performing step S1140, vibration is generated as the magnetic force generating means 1110 is moved by the magnetic force S1150.

On the other hand, steps S1110 to S1140 of the vibration generating method based on the movement of the electromagnetic force generating means are the same as described above. Then, vibration is generated as the electromagnetic force generating means 1120 is moved by the electromagnetic force S1250. At this point, the magnetic force generating means 1110 does not move and is fixed, and the vibration generating method can be performed by moving the electromagnetic force generating means 1120.

Vibration can be generated by inertia based on the movement of the magnetic force generating means 1110 or the electromagnetic force generating means 1120, whereas if a protecting means 1131 and a limiter means 1141 are further added, vibration can be generated by impact as the first mobile object 1130 and the second mobile object 1140 are moved.

<Recoding Medium>

The vibration generating method of the present invention can be implemented as a computer-readable code stored in a recording medium that can be read by a computer. The recording medium that can be read by a computer includes all kinds of recording devices storing data that can be read by a computer system. Examples of the recording medium that can be read by a computer are ROMs, RAMS, CD-ROMs, magnetic tapes, floppy disks, optical data storage devices, and the like, and the recording medium can be implemented in the form of carrier waves (e.g., transmission through the Internet). In addition, the recording medium that can be read by a computer can be distributed to computer systems connected through a network, and codes that can be read by a computer can be stored and executed in a distributed method. In addition, functional programs, codes, and code segments for implementing the present invention can be easily inferred by programmers skilled in the art of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A vibration generating module comprising:
a magnetic force generating means 110 for generating magnetic force; and
an electromagnetic force generating means 120 for generating electromagnetic force alternating depending on a magnetic pole change signal, wherein
vibration is generated as the magnetic force generating means 110 or the electromagnetic force generating means 120 is moved to one direction according to the magnetic pole change signal.

2. The module according to claim 1, wherein the magnetic force generating means 110 is provided in plurality.

3. The module according to claim 2, wherein the magnetic force is generated by opposing at least any one of magnetic poles formed by the alternating electromagnetic force to a magnetic pole of the plurality of the magnetic force generating means 110.

4. The module according to claim 3, wherein the magnetic force comprises attractive force and repulsive force.

5. The module according to claim 3, wherein the magnetic poles of the plurality of the magnetic force generating means 110 opposing each other are magnetic poles different from each other.

6. The module according to claim 3, further comprising:
a first mobile object 130 including the electromagnetic force generating means 120; and
a second mobile object 140 including the magnetic force generating means 110 inside and combined with the magnetic force generating means 110.

7. The module according to claim 6, further comprising:
an elastic means 150 combined with the second mobile object 140; and
a housing 160 combined with the elastic means 150, wherein the vibration is generated by inertia as the second mobile object 140 is moved.

8. The module according to claim 6, further comprising:
an elastic means 150 combined with a plurality of the electromagnetic force generating means 120; and
the second mobile object 140 combined with the elastic means 150, wherein the vibration is generated by inertia as the first mobile object 130 (←140) is moved.

9. The module according to claim 7, wherein the first mobile object 130 further includes a plurality of protecting means 131 for protecting the electromagnetic force generating means 120 from impact while moving together with the electromagnetic force generating means 120, and the second mobile object 140 further includes a plurality of limiter means 141 for impacting the protecting means 141 and generating vibration by the impact.

10. The module according to claim 9, wherein the magnetic force generating means 110 or the electromagnetic force generating means 120 is moved by the inertia at a resonant frequency.

11. The module according to claim 6, wherein the second mobile object 140 increases the magnetic force by forming magnetic paths 11 and 13 in a direction of an outer surface depending on a direction of the alternating electromagnetic force.

12. An actuator comprising:
a vibration generating module 100 including:
a magnetic force generating means 110 for generating magnetic force; and
an electromagnetic force generating means 120 for generating electromagnetic force alternating depending on a magnetic pole change signal; and
a control means 210 for outputting the magnetic pole change signal to the electromagnetic force generating means 120, wherein
vibration is generated as the magnetic force generating means 110 or the electromagnetic force generating means 120 is moved to one direction according to the magnetic pole change signal.

13. The actuator according to claim 12, further comprising:
a power supply means 220 for supplying electricity to the electromagnetic force generating means 120 and the control means 210.

14. A handheld device capable of generating vibration, the device comprising:
a vibration generating module 100 including:
a magnetic force generating means 110 for generating magnetic force; and
an electromagnetic force generating means 120 for generating electromagnetic force alternating depending on a magnetic pole change signal; and
an actuator 200 including a control means 210 for outputting the magnetic pole change signal to the electromagnetic force generating means 120, wherein
the vibration is generated as the magnetic force generating means 110 or the electromagnetic force generating means 120 is moved to one direction according to the magnetic pole change signal.

15. The device according to claim 14, further comprising: a microprocessor 310 for sensing a state of the handheld device 300 and outputting a control signal to the control means 210 in order to provided a sense of touch delivered by the vibration depending on the state.

16. The device according to claim 14, wherein the state of the handheld device 300 is at least any one of a press on a touch screen 320, a press on a keypad 330 displayed on the touch screen 320, execution of an application, and generation of an event.

17. A method for generating vibration using an actuator according to claim 12, the method comprising the steps of:
outputting a control signal to an electromagnetic force generating means 120, by a control means 210 6110;
generating electromagnetic force according to the control signal, by the electromagnetic force generating means 120 S120;
forming magnetic poles of the electromagnetic force generating means 120 based on the electromagnetic force S130;
generating magnetic force by the magnetic poles of the electromagnetic force generating means 120 and the magnetic force generating means 110 S140; and
generating the vibration by moving and colliding the magnetic force generating means 110 by the magnetic force S150.

18. The method according to claim 17, wherein the magnetic force comprises attractive force and repulsive force, and the electromagnetic force generating means 120 is fixed.

19. A method for generating vibration using an actuator according to claim 12, the method comprising the steps of:
outputting a control signal to an electromagnetic force generating means 120, by a control means 210 S210;
generating electromagnetic force according to the control signal, by the electromagnetic force generating means 120 S220;
forming magnetic poles of the electromagnetic force generating means 120 based on the electromagnetic force S230;
generating magnetic force by the magnetic poles of the electromagnetic force generating means 120 and the magnetic force generating means 110 S240; and
generating the vibration by moving and colliding the electromagnetic force generating means 120 by the magnetic force S250.

20. The method according to claim 19, wherein the magnetic force comprises attractive force and repulsive force, and the magnetic force generating means 110 is fixed.

21. The method according to claim 17, wherein the magnetic force is generated by opposing at least any one of magnetic poles formed by the alternating electromagnetic force to a magnetic pole of the magnetic force generating means 110.

22. A computer-readable recording medium for recording a program for executing a method for generating vibration according to claim 17.

23. A vibration generating module comprising:
a plurality of magnetic force generating means 1110 for generating magnetic force; and
an electromagnetic force generating means 1120 for generating electromagnetic force alternating depending on a magnetic pole change signal, wherein
the vibration generating module is configured in an unstable structure, in which a local magnetic path 10A is formed based on magnetic force lines of the magnetic force generating means 1110 and the electromagnetic force generating means 1120, and
vibration is generated as the magnetic force generating means 1110 or the electromagnetic force generating means 1120 is moved to one direction according to the magnetic pole change signal.

24. The module according to claim 23, wherein magnetic poles of the plurality of the magnetic force generating means 1110 opposing each other are magnetic poles different from each other.

25. The module according to claim 24, wherein the magnetic force is generated by opposing magnetic poles formed by the alternating electromagnetic force to the magnetic poles of the plurality of the magnetic force generating means 1110.

26. The module according to claim 25, wherein the magnetic force comprises attractive force and repulsive force.

27. The module according to claim 23, wherein the electromagnetic force generating means 1120 includes:
at least one iron core 1125 for forming magnetic poles alternating depending on the magnetic pole change signal; and
and a solenoid coil 1121 for winding to wrap the at least one iron core 1125.

28. The module according to claim 27, wherein the alternating magnetic poles are formed by providing eight magnetic force generating means 1110 and three iron cores 1125.

29. The module according to claim 24, further comprising:
a first mobile object 1130 including the electromagnetic force generating means 1120; and
a second mobile object 1140 including the magnetic force generating means 1110 inside and combined with the magnetic force generating means 1110.

30. The module according to claim 29, further comprising:
an elastic means 1150 combined with the second mobile object 1140; and
a housing 1160 combined with the elastic means 1150, wherein the vibration is generated by inertia as the second mobile object 1140 is moved.

31. The module according to claim 29, further comprising:
an elastic means 1150 combined with the electromagnetic force generating means 1120; and
the second mobile object 1140 combined with the elastic means 1150, wherein the vibration is generated by inertia as the first mobile object 1130 is moved.

32. The module according to claim 30, wherein the first mobile object 1130 further includes a plurality of protecting means 1131 for protecting the electromagnetic force generating means 1120 from impact while moving together with the electromagnetic force generating means 1120, and the second mobile object 1140 further includes a plurality of limiter means 1141 for impacting the protecting means 1141 and generating vibration by the impact.

33. The module according to claim 32, wherein the magnetic force generating means 1110 or the electromagnetic force generating means 1120 is moved by the inertia at a resonant frequency.

34. An actuator comprising:
a vibration generating module 1100 including:
a magnetic force generating means 1110 for generating magnetic force; and
an electromagnetic force generating means 1120 for generating electromagnetic force alternating depending on a magnetic pole change signal; and
a control means 1210 for outputting the magnetic pole change signal to the electromagnetic force generating means 1120, wherein
the actuator is configured in an unstable structure, in which a local magnetic path 10A is formed based on magnetic force lines of the magnetic force generating means 1110 and the electromagnetic force generating means 1120, and
and vibration is generated as the magnetic force generating means 1110 or the electromagnetic force generating means 1120 is moved to one direction according to the magnetic pole change signal.

35. The actuator according to claim 34, further comprising:
a power supply means 1220 for supplying electricity to the electromagnetic force generating means 1120 and the control means 1210.

36. A handheld device capable of generating vibration, the device comprising:
a vibration generating module 1100 including:
a magnetic force generating means 1110 for generating magnetic force; and
an electromagnetic force generating means 1120 for generating electromagnetic force alternating depending on a magnetic pole change signal; and
an actuator 1200 including a control means 1210 for outputting the magnetic pole change signal to the electromagnetic force generating means 1120, wherein
the handheld device is configured in an unstable structure, in which a local magnetic path 10A is formed based on magnetic force lines of the magnetic force generating means 1110 and the electromagnetic force generating means 1120, and
the vibration is generated as the magnetic force generating means 1110 or the electromagnetic force generating means 1120 is moved to one direction according to the magnetic pole change signal.

37. The device according to claim 36, further comprising: a microprocessor 1310 for sensing a state of the handheld device 1300 and outputting a control signal to the control means 1210 in order to provided a sense of touch delivered by the vibration depending on the state.

38. The device according to claim 36, wherein the state of the handheld device 1300 is at least any one of a press on a touch screen 1320, a press on a keypad 1330 displayed on the touch screen 1320, execution of an application, and generation of an event.

39. A method for generating vibration using an actuator according to claim 34, the method comprising the steps of:
outputting a control signal to an electromagnetic force generating means 1120, by a control means 1210 S1110;
generating electromagnetic force according to the control signal, by the electromagnetic force generating means 1120 S1120;
forming magnetic poles of the electromagnetic force generating means 1120 based on the electromagnetic force S1130;
generating magnetic force by the magnetic poles of the electromagnetic force generating means 1120 and the plurality of magnetic force generating means 1110 S1140; and
generating the vibration by moving and colliding the plurality of magnetic force generating means 1110 by the magnetic force S1150, wherein
the vibration generating method is performed in an unstable structure, in which the magnetic force interacting between the electromagnetic force generating means 1120 and the magnetic force generating means 1110 is formed based on magnetic force lines of the electromagnetic force generating means 1120 and the magnetic force generating means 1110.

40. The method according to claim 39, wherein the magnetic force comprises attractive force and repulsive force, and the electromagnetic force generating means 1120 is fixed.

41. The method according to claim 39, wherein in step S1150, the vibration is generated by inertia or impact as the magnetic force generating means 1110 is moved.

42. A method for generating vibration using the actuator according to claim 34, the method comprising the steps of:
outputting a control signal to an electromagnetic force generating means 1120, by a control means 1210 S1210;
generating electromagnetic force according to the control signal, by the electromagnetic force generating means 1120 S1220;
forming magnetic poles of the electromagnetic force generating means 1120 based on the electromagnetic force S1230;
generating magnetic force by the magnetic poles of the electromagnetic force generating means 1120 and the plurality of magnetic force generating means 1110 S1240; and
generating the vibration by moving and colliding the electromagnetic force generating means 1120 by the magnetic force S1250, wherein
the vibration generating method is performed in an unstable structure, in which a local magnetic path 10A is formed based on magnetic force lines of the electromagnetic force generating means 1120 and the magnetic force generating means 1110.

43. The method according to claim 42, wherein the magnetic force comprises attractive force and repulsive force, and the magnetic force generating means 1110 is fixed.

44. The method according to claim 42, wherein in step S1250, the vibration is generated by inertia or impact as the electromagnetic force generating means 1120 is moved.

45. The method according to claim 39, wherein the magnetic force is generated by opposing the magnetic poles formed by the alternating electromagnetic force to the magnetic poles of the magnetic force generating means 1110.

46. A computer-readable recording medium for recording a program for executing a method for generating vibration according to claim 39.
